(19) United States
(12) Patent Application Publication
(10) Pub. No.: US 2010/0145774 A1
(43) Pub. Date: Jun. 10, 2010

(54) METHOD FOR VOTING PREPARATION AND IMPLEMENTATION BY MEANS OF AN AUTOMATED OPERATIONAL INFORMATION SYSTEM

(75) Inventors: Alexandr Albertovich Veshnyakov, Moscow (RU); Viktor Vasilievich Yaschenko, Moscow (RU)

Correspondence Address: Locke Lord Bissell & Liddell LLP;Attn: IP Docketing, Three World Financial Center, New York, NY, 10281-2101, US

(73) Assignee: Federal Center of Informatization at the Central Election Commission of the Russian Federation, Moscow (RU)

(21) Appl. No.: 11/909,307

(22) PCT Filed: Jul. 8, 2005
(86) PCT No.: PCT/RU2005/000375

§ 371 Date: Mar. 17, 2008

(30) Foreign Application Priority Data
Mar. 24, 2005 (RU) 2005108181

(51) Int. Cl. G06Q 10/00; G06F 17/30

(52) U.S. Cl. 705/12; 707/769; 707/E17.005; 707/769; 707/E17.014; 707/781

(57) ABSTRACT

The invention relates to information computer engineering and is embodied in the form of a method for preparing and running a vote process with the aid of an automated system comprising a territorially distributed voting network consisting of territorial stations, a central control station and an automated operation and information system comprising a system element network consisting of software-hardware means systems which are interconnected with the aid of acceptable communications means and make it possible, in an access mode and in a real time scale and/or during a session, to receive information from the voting network elements, to process said information in such a way that the data objects are represented in a textual and/or graphical and/or digital and/or matrix format, to input identification data items about the voting network and system element into the data objects, to record, collect, store, transmit, statistically process, display and visualise the data objects and to form an integrated database of an election campaign or referendum, simultaneously produce requested data blocks and to supply said blocks in a view mode, through the Internet network and/or for in-line open familiarisation with information and for in real time visualising the information about the vote campaign preparation and running on the large-sized group display means.

### FIELD OF THE INVENTION

The invention relates to information technologies, and, more particularly, to systems for operational and information support of voting preparation and implementation procedure and for summarizing the voting results used for various purposes on territories of a different extent.

### BACKGROUND OF THE INVENTION

It is well known that the voting right is one of the basic principles of democracy guaranteeing involvement of citizens in a political life at a country level, and at national, regional and local levels and, therefore, the procedures used for voting preparation and implementation should correspond to the principles of democratic elections and referendums.

The urgency of automation in the processes of operational and information support of the activity of organizational structures and citizens in preparation and implementation of various elections and referenda is obvious.

Information and communication technologies are used more and more in everyday life, and are also used for involvement of the population in the course of preparation and implementation of elections and referenda including a rise of people knowledge of the population about the legal bases of a daily life and their rights, measures on strengthening the democratic base of the voting systems are well grounded.

According to the Guidelines of the Council of Europe, when using the operational and informational technologies for voting support and implementation, the voters should be provided with a possibility of voting not only at the polling place of their election district but also in other places and with other voting capabilities. In addition, maximum participation of all citizens having the voting right should be provided with a possibility of participation in voting and referenda with an access to election process even if these are invalid voters and those who cannot be present physically at the polling place and to use the resources available. In so doing efficiency and reliability should be provided during the transfer of the voting results, as well as the information on the course of preparation and implementation of voting, information on the variants to be given to a voter for realization of his or her election including information on the candidates.

In this case, it is necessary to prevent double voting by one voter with respect to one selection variant and only one voting channel with application of safe and reliable methods of summing up all voices and finding a correct result.

Besides, voting should be secret and organized so that at any stage of the voting procedure, in particular, at a stage of establishment of the voter identity to eliminate everything that could break the secret of the voter's will, and the count of votes should eliminate a possibility of establishment of any link between the vote cast and a concrete voter. Therefore, it is necessary that the expected number of cast votes in the bulletin reception device does not give a possibility of linking the result obtained with a concrete voter. Under conditions of a monitored environment the information on the cast vote should be hidden as soon as the vote cast is over.

Besides, the system should provide availability and integrity of cast votes, as well as their confidentiality prior to the beginning of vote count. In so doing the data on the quantity of voices submitted for this or that election variant should not be available to the public until the moment of closing the voting.

At any election it is necessary to have a regularly updated accessible and complete electoral register and a list of participants of a referendum, as well as a list of candidates. The voter should have a possibility to check up the information about him in the electoral register. A mechanism of establishment of voter identity is thus necessary.

The voting bulletin should be authentic at all voting sites, and the fact that the voice has been cast should be well documented.

In so doing for compatibility of the technical components used in the system equipped with components of different manufacturers, it is necessary to use common standards.

The legal acts regulating elections or a referendum should accurately define the time frames concerning all stages of the elections or referendum both prior and after thereof.

Much attention has been paid to the solution of this problem.

Known in the art are various developments which foresee the use operational and information support of the process of preparation and implementation of elections and referenda, systems of registration and count of the total quantity of voices as information objects fed to an operational and/or intellectual system for structured information processing and subsequent allocation for usage.

Known in the art are a method and a system for conduction of voting among a plurality of voters including submission to the voter of a primary bulletin having a part for voting and a unique identifying part, acquaintance by the voter with answers in the voting part, creation of a secondary bulletin by making a copy of the first bulletin, return of the first cast vote bulletin to the voter, display of all secondary bulletins recorded during the voting, a permission for each voter to view or correct to exact correspondence of the displayed bulletin to the primary bulletin, confirmation by the voter of the corrected records in the secondary bulletin, presentation in a tabulated form of the confirmed voices, proclamation of the tabulated records, a permit to the opposition to view or correct the tabulated records according to the approved voters' selection, recording of the results of the review or correction of the tabulated records (U.S. Pat. No. 6,726,090, B1). In so doing the bulletin can be marked by at least one identification character for a characteristic of the primary bulletin, the secondary bulletin is marked similarly by another character, and are marked by respective identical characters, calling the voter to the official representative of election campaign with claims if the secondary and primary bulletins are not identical.

Also known in the art are method and system including submission to a plurality of voters of displayed information according to the voting system comprising at least two selections, and each displayed image relates to one selection, a count of the quantity of images, automatic detection of relations of the cast votes, determination of the total relations of the cast votes (U.S. Pat. No. 6,739,508, B2)

Known in the art is a voting system for voters at a place of their residence including a control computer of an election campaign submitting election data including one or more bulletins and a voter identifier, an integrated official smart card configured by said computer, a smart card activation device and an voting machine which reads out the voter identification code from the smart card and the voter password, displays at least one bulletin for voting to the identified voter (U.S. Pat. No. 6,550,675, B2). The system provides discussion with the voter about his/her election variants and saving the discussion results after the voting.

Known in the art are voting method and system intended for independent checking the bulletin, in which the voting is carried out using a voting computer station adapted for submission of a bulletin, acceptation of the voter's selection according to the bulletin, temporary saving the voter's selection, printing the voter's selection from the temporary storage, comparison of the printed election with the temporarily saved election by the voter, a decision of the voter on the election correctness, saving the final election results and direction of the bulletins with a selection for registration (U.S. Pat. No. 6,769,613, B2).

Also known in the art is a voting system for simplifying the selection according to the jurisdiction including a central computer, a managing agent for remote voting comprising a database, a mobile storage device compatible with the central computer and used for transmission and data acquisition from the central computer and compatible with the managing agent, data transfer and data acquisition from the database, in which the data are saved in a mobile storage of a battery supplied storage device. In this system said managing agent has a resource for creation of an electronic version of the selection made and its saving in a database, and in which the mobile storage device has a possibility of moving between the managing agent and the central computer for data transfer therebetween. (U.S. Pat. No. 6,641,033, B2). In so doing the storage device may contain an image of many types of bulletins according to the jurisdiction, and the system may comprise an additional voting server for guiding the bulletin recognized as submitted into a database by telecommunication means.

Known in the art are method and system for obtaining voters' opinions and estimation concerning various objects, in which the voter is given information including opinions of the other voters with whom he may agree or disagree, or introduce another idea, and search a database for finding out all possible variants. In thus case, the system includes a database for information storage, a personal computer, a web server and a means for communication with the database; the voting results are processed in the personal computer with a displayed image of ratio of opinions (WO 00/17824, A1).

Also known in the art are method and system for communication of mobile terminals with a database by means of a communication system comprising a source of information, a positional transceiver placed at the place of location of a broadcast system and connected to a data source, and the transmitted information contains data identifying the information source and a mobile terminal including a first transceiver connected to the positional transceiver and a second transceiver connected to a network, and in which the identifying information includes a point which identifies the location of the positional transceiver with respective data in the data source (U.S. Pat. No. 6,549,625 B1).

In addition, known in the art are developments of methods of forming information to create databases for storing various information on the course of voting and referenda preparation and implementation, which may be given to users including voters, to official bodies carrying out the voting preparation and implementation, to monitoring bodies and to independent observers.

For example, there is known a computer-based method of saving configured information for a computer network including creation of a domain having a logically organized structure and comprising a plurality of domains, each domain being linked with one or more computers of the network, and each domain including a name and address of a server for each domain located in a logical directory or a directory belonging to this domain, and creation in each database domain respective information on this domain and these resources, and saving said database in a data storage medium of at least one computer linked with this domain, as well as a method of saving configured information in a network database (U.S. Pat. No. 5,664,170 A).

Known in the art is a method using container objects compatible with computers for exchange with names of informational products and with their appropriate information content saved in a storage device compatible with the said container objects (U.S. Pat. No. 6,230,211 B1).

For example, known in the art is a method of organization of objects of information into a block of hierarchically structured data using a computer system with provision of an object of information including the object itself, its attributes and their interlinking, creation in a dynamic mode of an information package from the objects identified as meeting the content of the package and building-up a hierarchic structure using said object of information, and a computer program for decryption of the structure of the hierarchical organization of said information packages in a dynamic mode (U.S. Pat. No. 6,721,757 B2).

A lot of attention is also given to the problem of a quick and reliably protected method of submission of information kept in databases to users of various levels with various scope of access to such information.

For example, known in the art are method and system for monitoring the user calls to the network environment resources in a computer network having a plurality of users and comprising a computer-server monitoring the information resource organized as a hierarchic structure of elements including higher-level elements and additional elements subordinated to the higher-level on the hierarchy. In this system modification of the resource attributes is performed by receiving a request for updating the attribute from the first element of the hierarchic structure with an access to the network for the user who is special for the additional element, determine the correspondence of the attribute to the list of attributes in the first element, identify a second element subordinate to the first one, form a copy of the list of attributes of the second element, update the copy according to the order on updating the attributes and put the updated copy of the list of attributes in the first element (U.S. Pat. No. 6,061,684, A).

However, the above described methods and systems can function only as parts of automation of operational and information processes since they do not allow one to carry out organization of operational and information service of a full cycle of the step-by-step preparation and implementation of elections and referenda and to use the already accumulated experience and information for conduction of new election campaigns using standard equipment, as well as to provide applicability of various voting resources in one election campaign acceptable for regions with various territorial extent and various personnel support.

An object of the present invention is to create of a method and a system of voting preparation and implementation providing solution of organizational tasks of voting preparation and implementation including submission of operational and information support of the activity of organizational structures on large territories with provision of information for usage not only in a specific case of voting implementation but also for the future election campaigns and elections at various level in various voting regions with application of various methods of supplying the voter with election possibility, wide open acquaintance with the information on the course of preparation and voting during the implementation of an election campaign or a referendum, as well as protection of the operational and information processes from unauthorized access and protection of information in the system.

Another object is to develop a method for voting support, preparation and implementation at all levels, in which the activity of the organizational structures engaged in the voting preparation and implementation, as well as the operation on forming voting bulletins, with respect to the information transfer, registration of voters and vote tabulation are structured by operations with creation of information objects fulfilled in an accepted single format and allowing one to make reception, processing, saving and submission to users of the information with application of common high-efficiency technologies in a convenient form for acquaintance and ordering in an automatic mode by means of soft/hardware complexes while observing the general prescribed requirements of the regulatory legal acts, formalized parameters and criteria of selection and checking, and the prepared and submitted information is to be saved with a possibility of its recovery for future application.

These objects are obtained by developing a method of voting preparation and implementation by means of an automated system in which performs the following working steps:
forming a territorially distributed voting network containing at least the following elements:
territorial sites placed in voting regions and providing at least:
   open acquaintance with the information on the forthcoming voting;
   registration of voters;
   presenting to the voter of a bulletin containing at least two selection variants and made on a suitable carrier with a possibility of making a mark in the selection field;
   calculation of quantity of the issued bulletins;
   reception of the bulletin filled by the voter;
   calculation of a number of accepted bulletins;
   calculation of quantity of marks made by the voter with respect to a selection variant;
   generation of the return data containing information objects in the preset format; and
   a central control station,
      interconnected by means of suitable communication facilities, said sites being adapted at least for capture, reception, registration, processing, saving and delivery of information in a preset format;
development of an automated operational information system for voting preparation and implementation, including a network of territorially distributed elements of the automated system including complexes of soft/hardware means, and interconnected by suitable communication facilities and allowing one to perform the following operations in an authorized access mode in real time and/or in session time:
receiving initial information containing information objects prepared by the voting network elements in a preset format and input of the information into an element of the automated system;
processing said information with a possibility of its display in a text and/or graphic and/or digital and/or tabulated form and with a possibility of editing said image;
review of the displayed information objects, checking their correspondence to the information prepared by the voting system elements;
input of additional data in said information objects allowing one to identify said objects as objects information relating to the election in a definite instant of time and to identify the element of the automated system providing input of said information into said automated system;
subsequent recording and storing said information objects with a possibility of data processing by the cumulative total method;
transfer of the information objects to the other elements of the system;
display and visualization of the information objects;
saving of said information objects;
identification of the user of the automated system at his call to the element of the automated system; and the system contains peripheral and central elements and:
at least one of the central elements is the central control element of the said system and is further adapted for monitoring the operation of other elements of automated system, and the automated system comprises:
at least one unit of system adapted for connection with external databases and having a possibility of reception of request from the system element containing at least data on the information object requiring explanation and/or additional information from the other databases, and identifying index of the system element and directing it the other databases, receiving a response and sending an answer to the system element which sent the request;
at least one system element linked at least with one central element and with a database server of the system and adapted for:
   granting the users with access to information resources of the automated system via the Web network;
   provision of open acquaintance in the on-line mode on accessible display and visualization means of the information in the voting progress with an image of preliminary voting results automatically processed in real-time mode in the voting region;
   publication in the Internet network of the information on the voting progress and the total voting results within 24 hours after the voting is over;
   using large-size multiple-access visualization devices for display of the information on the voting progress and voting summary;
   provision of the complex of soft/hardware means of said system elements with general-purpose soft- and hardware allowing one to carry out on-line in an automatic mode monitoring of their state by testing, remote distribution, inventory and upgrading the dedicated soft-and-hardware providing reception, processing and transmission of data transfer in the process of performing the duty of information exchange between the system elements and with an environment, as well as adjustment of the system elements for solving functional tasks of different complexity;
provision of the voting network and the automated voting system with skilled personnel, and carry out their training;
providing an information transfer from the elements the voting network to the elements of the automated system;
forming a common database of the automated system, thus performing the following steps:
reception, record, accumulation and saving of the information objects incoming in real time and/or in session time from the automated system elements;
processing the received information objects with creation of address blocks including information objects relating to one type of voting and/or one element of automated system and/or to one of the voting network element and/or one direction of activity of the system elements and/or one user, and savings of the address blocks with a possibility of their recovery;
processing the information of the address blocks with creation of final data blocks containing information with cumulative total and saving the final data blocks with a possibility of their recovery;
providing each of said information objects, address summary data blocks, statistical data blocks with an additional classification index allowing each of said objects and/or blocks to be identified in the database;
generation of data blocks containing information stored in the common database according to the dispatch regulations provided for the users registered in the database;
generation of open data blocks according to the prescribed list of information for the future open representation by means of visualization tools;
generation of data blocks according to the established list of information for the subsequent presentation in sites of the Internet network;
saving the copies of the initial and updated data blocks of the common database on a carrier suitable for operation in an automated system not linked to the database;
registration of the issue and movement of strict accountancy documents including voting bulletins;
saving the package of general-purpose software installed in the automated system elements and the results of their testing during monitoring;
   saving the copies of the initial and corrected data blocks of the common database on a carrier acceptable for operation in the automated system not connected to a database;
   registration of the issue and movement of strict accountancy documents including voting bulletins;
   saving the general-purpose software packs installed in the elements of the automated system including initial packs and service packs,
   saving the dedicated software packs installed in the elements of the automated system including initial packs and service packs,
      and providing operation of said automated system in an interactive mode for directory service of users of a common database and support of operation of elements of automated system and elements of a voting network and, thus in an automatic mode provide:
support of the information stored in the common database in an actual state by means of correction and updating;
reception of a user call in the common database and its saving;
checking the presence an identification index in the call, determining the scope of the user's access rights, establishing the scope of access to the information in the common database,
search of information in the common database, according to the call and the scope of rights given to the user,
generation of a response block to response to the user call,
providing the user with a generated response block in the browse mode according to scope of rights given to the user if the user call to the database contains an identification index corresponding to the identification index of this user stored in said common database;
forming a voting bulletin containing at least information allowing one to identify the accessory of the bulletin to the voting bulletins including at least two selection variants from the amount of the registered selection variants and having at least two localized selection fields adapted for making a selection by introducing by the voter marking element in one of the selection field;
making a voting bulletin on a carrier acceptable for voting;
registration of voters;
giving the voting bulletin to and taking it from the voter;
counting the accepted bulletins and checking them for correspondence to the established requirements of recognizing the bulletin as valid;
counting the votes concerning each selection variant;
generating data on the course of voting and its results;
forming summary data on the voting by performing the following steps:
providing a possibility of data exchange between the voting network elements and the automated system elements;
performing automatic protection of the automated system against unauthorized access;
providing information security;
giving to the users an access to the information resources of the automated system on the Web-technology basis;
on-line open access to the information on the course of voting and on the preliminary voting results being automatically processed in a real-time mode in the voting region by means of a suitable interface and displays at sites of the voting network and in the voting region as a whole;
publication in the Internet network of the information on the course of voting and the total voting results within 24 hours after the voting is over;
displaying the data on the course of voting and the final voting on large-size displays.

According to the invention, it is expedient that when creating said territorially distributed automated system, the peripheral elements of said system are located in voting region.

Besides, according to the invention, to users of the common database are submitted with information generated in blocks:
information on the beginning of the election campaign;
data including regulatory legal acts regulating the activity on the voting preparation and implementation and necessary legal information;
data containing time schedules of work on voting preparation and implementation and on the final voting results;
data containing information on administrative territorial division of the voting region;
data on the operation of the central control station and territorial voting network sites during the voting preparation and implementation;
data including documentary forms prescribed for reports in various organizational structures connected with the voting with a possibility of filling these forms,
data including preliminary, current and total reports on the voting preparation and implementation;
data generated in the course of the voting preparation and implementation by each automated system element,
data on the voting preparation and implementation at a definite site of the voting network,
data on the object to be included in the number of selection variants for voting;
data including a list of registered selection variants for voting,
data on prospective voters;
data including lists of prospective voters according to the administrative territorial division of the voting region;
data including a form of the voting bulletin and requirement to its content;
data on the formed voting bulletin with a possibility of its duplication on a carrier acceptable for voting;
data on registration of the voter and on the voting bulletin submitted to him;
data including lists of registered voters including results of checking said lists for the presence of “doubles”,
data on the voting process dynamics and on the quantity of cast votes during the voting time;
data containing information on the beginning, end and content of the agitation campaign in a voting region;
data containing information on the voting summary in the voting region and/or its administrative-territorial voting sites;
data containing information on the documents granted to the elected person,
data of the statistical processing of the obtained information supplied from the system elements and from the voting network elements in the process of voting preparation and implementation;
information on closing the voting;
data containing information on arrival, expenditure and return of monetary funds intended for voting preparation and implementation;
information on termination of the election campaign;
information on termination of the powers of an official and/or authority;
information on granting the powers to the elected official and/or authority;
information submitted in accordance with a prescribed list of information given for the future open access to mass media and/or acceptable visualization tools;
information submitted in accordance with a prescribed list of information submitted for future display on sites of the Internet network;
information on the operation of the soft/hardware elements of the automated system and communication facilities and on the results of monitoring their status and service with a possibility of displaying the information contained in said blocks on a display.

Besides, according to the invention, it is expedient that the data containing information on the regulatory legal acts on the voting preparation and implementation at least includes:
voting type and purpose;
   voting region and its division into administrative-territorial sites for voting preparation and implementation;
date and time of the beginning and end of the voting preparation procedure;
date and time of the beginning and end of the voting;
criteria on estimation of the selection variant for its registration as a variant given for voting in the voting region and/or its voting sites;
voting resources rendered to the voter for realization of his/her selection rights;
voter identification parameters;
criteria for recognizing the voter as registered for voting purposes;
criteria for recognizing the bulletin filled by the voter as valid and for the selection being made;
criteria for recognizing report of the site of the voting network on the voting results as valid;
criteria for recognizing the voting as implemented;
indexes assigned to said type of data for their identification in the common database information content.

It is also reasonable that the data containing information on the administrative territorial division of voting region comprise an image of the voting region map with an indication of boundaries of the region into division in sites, with a possibility of detailing the parameters of the site for voting purposes.

In addition, in the system according to the method according to the invention the data on the operation of the voting structures, which are carrying out the activity on the voting preparation and implementation include at least:
regulatory legal acts regulating their action;
functional features of said sites, their interaction, and a hierarchic structure of the voting network;
prescribed forms of accounts and reports;
information on the personnel;
a scope of rights given to the personnel for carrying out their activity;
information on special identification indexes assigned to each of the elements of the system, which must be included in the volume of the information block generated by said elements for input into said common database and/or for transfer to other elements and/or automated system, and allowing said automated system to identify the data source, and the information by accessory;
data generated in the course of the voting preparation and forming voting documents including accounting documents;
information generated by the element of the automated system in said data blocks containing information received by the system in the course of the voting preparation and implementation, and providing a possibility of its display in the form of a text and/or graphics and/or digits and/or a table;
date and time of the beginning and end of the activity of said voting network cites.

In addition, in the method according to the invention the data on the object to be included in the number of selection variants for voting comprise at least the following:
parameters allowing one to identify an object of a supposed selection among the other supposed selection objects;
data necessary for conduction by the voter of comparative estimation of the selection variants;
data registered according to the requirements of the regulatory legal acts for selection variants submitted for voting, in the scope of data necessary for conduction of comparative estimation of the selection variants;
information on the selection variants which have been given up in registration, and on the reasons of such a refusal.

Besides, in the method according to the invention the data on a prospective voter comprise at least the following:
data on the person who has reached the age of legal capacity for voting residing within the administrative-territorial site of the voting region allowing the system to identify him among the other persons living in this area,
data on the voting process participant necessary and sufficient for his identification among prospective voters,
a list of prospective voters reached the age of legal capacity for voting and living in one of the administrative-territorial sites of the voting region,
data on the person who has reached the age of legal capacity for voting who expressed a desire to vote at a voting site which is not his residence place,
data of the documents given to the voter by his request for voting at a voting site which is not his residence place.

Thus, according to the invention, the voting purpose can be selected from the group including a referendum, presidential elections, election of a higher official, election of a head of a municipal union, election of a head of administration, election of a deputy, a recall of a person from an elective post, a recall of a deputy.

Besides, according to the invention, the type of election may be selected from the group including direct voting and correspondence voting.

In this case, according to the invention, the voting region may be selected from the group including a state, a federal union, a Federation subject, a municipal union, an administrative-territorial site.

Besides, to the invention, the voting preparation and implementation in one voting region may be carried out simultaneously for the several voting objects at any combination of the voting objects and types.

In so doing, according to the invention, the voting may be conducted for referendum, a recall of a person from an election post, a recall of a deputy, the selection variant being an answer to at least on one question, the bulletin has at least two selection fields for an answer to one question, and the answer is recorded in the bulletin by introducing a marker element in one of the two selection fields.

It is expedient that, according to the invention, the voting preparation and implementation is for the purposes selected from the group including presidential election, a higher official election, election of the head of a municipal union, election of the head of an administration, election of a deputy, in which case, and the common database of the of the automated system further include:
Data on registration of an election campaign with assignment to it a special code index which must be included in the information blocks concerning voting preparation and implementation for a selected purpose, and allowing one to identify such an information in the information content in the common database including:
information on the beginning of the election campaign;
information on the beginning and end, and on the content of the agitation campaign;
information on the termination of the election campaign;
information on the termination of the powers of an official and/or authority;
information on granting the powers to the elected official and/or authority;
data on the election collectives including political parties and/or election blocks and/or initiative groups of voters slating a candidate including:
information on the involvement of said election collectives in election campaigns;
information on the authorized representatives of the election collectives;
data on the candidate slated by the election collective;
data on the authorized representatives of the candidate;
data on the documents granted to the registered authorized representative;
data on obtainment and expenditure of the money resources of the election funds of the candidates and on the obtained budgetary funds;
data on the registration of the candidate to be included in the bulletin as a voting object;
data of the documents granted to the elected person; and additionally:
checking the legitimacy of the donations;
checking the utilization and return of budgetary funds including for free broadcasting time and printing areas;
checking the data on the candidate property and income;
forming and handing to the candidate the documents of his registration;
forming and handing to the candidate representative the documents of his election

Besides, according to the invention, the automated system elements can be placed at allocation of the voting network elements.

In so doing, according to the invention, the voting network may have a multi-level in accordance with the established administrative territorial division of the voting region and hierarchy of subordination of the voting network elements.

It is expedient that the parameters of identification of a voter include his surname, name, patronymic, date of birth, birthplace, and a place of living or registrations and an identity card.

Besides, the method according to the invention provides the information submitted to the user for review is in the form of data blocks to be displayed on a display and selected from the group including:
a data block containing an index identifying this user;
a data block containing information permitted for access to the user authorized for this access;
a data block for open acquaintance.

Besides, according to the invention, the method for voting preparation and implementation provides the user in a real-time and/or session mode with an image of the statistical information on the voting preparation and implementation on an appropriate cartographic image of the territory and/or areas of an administrative territorial division of the voting region and/or the voting region as a whole.

The object of the invention is also attained by creation of an automated system for realization of the method of voting preparation and implementation including:
a territorially-distributed voting network comprising elements of a network such as:
territorial sites arranged in the voting regions and used at least for:
   open acquaintance with the information on the forthcoming voting,
   registrations of voters,
   providing the voter with a bulletin containing at least two selection variants and made on a suitable carrier with a possibility of making a mark about the selection made,
   calculation of quantity of issued bulletins,
   reception of the bulletin filled by the voter,
   calculation of the amount of the accepted bulletins,
   calculation of the amount of the marks made with respect to one selection variant, and
   a central control station,
      interconnected by means of suitable communication facilities, said sites being used at least for capture, reception, counting, registration, processing, saving transfer of the information in a preset format;
an automated operational information system comprising a necessary amount of system elements, setting up a territorially-distributed structure having central and peripheral system elements connected to each other and to all other system elements being a server, in which the connection between the elements is effected by means of suitable communication facilities like an Intranet network, and each of said automated system elements includes complexes of soft/hardware means provided with the standard program-technical means allowing one to perform on-line automatic loading, adjustment, monitoring and correction of their state in real time and/or in session time;
reception of information containing information objects prepared by the voting network elements in a preset format, and input of the information objects in the element of the automated system;
processing said information in a digital form to generate data blocks containing said information objects and providing a possibility of their display as a text and/or graphics and/or digits and/or a table with a possibility of editing said image;
review of the displayed information objects, checking their correspondence to the initial information prepared by the voting network element;
input of additional data in said information objects allowing one to identify said information as information relating to the election in a definite instant of time and to identify the element of the automated system providing input of said information into said automated system;
subsequent recording and storing said information objects with a possibility of data processing by the cumulative total method;
transfer of said information objects to the other elements of the system;
display and visualization of said information objects;
saving said information objects;
identification of the user of the automated system at his call to the automated system element; the database server is also adapted to automatically create a common database by:
reception, record, accumulation and saving of the information objects incoming in real time and/or in session time from the automated system elements;
processing the received information objects with creation of address blocks including information objects relating to one type of voting and/or one element of automated system and/or to one of the voting network element and/or one direction of activity of the system elements and/or one user, and savings of the address blocks with a possibility of their recovery;
processing the information on the address blocks with creation of final data blocks containing information with cumulative total and saving the final data blocks with a possibility of their recovery;
processing the information contained in said data blocks, address blocks and final data blocks with creation of statistical data blocks by the parameters prescribed by normative legal acts and their saving with a possibility of their recovery;
providing each of said address blocks with final data of an additional classification index allowing each of said blocks to be identified in the database;
saving the software packs installed in the automated system elements including the initial and service packs, and the results of testing the state of the soft/hardware means of the automated system elements during monitoring;
generation of data blocks containing information stored in the common database according to the dispatch regulations provided for the users registered in the database;
generation of open data blocks according to the prescribed list of information for the future open representation by means of visualization tools;
generation of information objects according to the installed list of information for the subsequent allocation on sites of the Internet network;
saving the copies of the initial and updated data blocks of the common database on a carrier suitable for operation in an automated system not linked to the database;
registration of the issue and movement of strict accountancy documents including voting bulletins;
creation of a voting bulletin block containing information allowing one to identify the bulletin as a voting bulletin including at least two selection variants from the registered selection variants and having at least two localized selection fields adapted for making the election by introduction a marking element by the voting participant in one of the selection fields;

In so doing the automated system provides a possibility of:
data exchange between the voting network elements and the automated system elements;
supports of operation of the system and common database in an interactive mode for directory service of the users, automated system elements and voting network elements with performance of a complex of works on:
maintenance of the information contained in the common database in an actual state by means of its correction and updating;
reception of users call to the common database and saving this call;
verifying whether the call has an identification index, verification of the user's access rights given of the calling user concerning the access to the information stored in the common database,
search of information in the common database associated with the user's call and checking the user authorization,
creation of a response to the user call,
sending a response to the user in the browse mode according to the scope of rights of the calling user if the user call to the database includes an identification index corresponding to the identification index of this user in said common database;
automatic performance of a complex of operations on protection of the automated system against an unauthorized access;
a complex of operations on information security;
   in which case at least one of the central elements is a central control element of said system and is also adapted for monitoring the operation of the other elements of the automated system, and the automated system includes:
at least one system element adapted for connection with other databases and made with a possibility of reception of a request from a system element containing at least data on the information object requiring an explanation and/or additional information from the other databases and identifying the index of a system element producing a request, its direction to the other databases, receptions of an answer and direction of the answer to the system element which have sent the request;
at least one system element connected to one central element and to the database server of the system and used for:
user access to the information resources of the automated system via the Web network;
on-line access to the information on the course of voting and on the preliminary voting results being automatically processed in a real-time mode in the voting region by means of a suitable interface and displays;
publication in the Internet network of the information on the course of voting and the total voting results within 24 hours after the voting is over;
displaying of the information on the course of voting and voting results on a large multiple-access display.

Besides, according to the invention, the voting region is a territory of allocation of the peripheral elements of said automated operational information system.

Also, according to the invention the users are given information generated in blocks:
information on the beginning of the election campaign;
data including regulatory legal acts regulating the activity on the voting preparation and implementation and necessary legal information;
data containing time schedules of work on voting preparation and implementation and on the final voting results;
data containing information on administrative territorial division of the voting region;
data on the operation of the central control station and the territorial sites of the voting network during the voting preparation and implementation;
data including documentary forms prescribed for reports in various organizational structures connected with the voting with a possibility of filling these forms
data including preliminary, current and total reports on the voting preparation and implementation;
data generated in the course of the voting preparation and implementation by each automated system element,
data on the voting preparation and implementation at a definite point of the voting network,
data on the object to be included in the number of selection variants for voting;
data including a list of registered selection variants for voting,
data on prospective voters;
data including lists of prospective voters according to the administrative territorial division of the voting region;
data including a form of the voting bulletin and requirement to its content;
data on the formed voting bulletin with a possibility of its duplication on a carrier acceptable for voting;
data on registration of the voter and on the voting bulletin submitted to him;
data including lists of registered voters including results of checking said lists for the presence of “doubles”,
data on the voting process dynamics and on the quantity of cast votes during the voting time;
data containing information on the beginning, end and the content of the agitation campaign in a voting region;
data containing information on the voting summary in the voting region and/or its administrative-territorial voting sites;
data containing information on the documents granted to the elected person,
data on the statistical information processing incoming from the system elements and from the voting network elements in the course of voting preparation and implementation;
information on closing the voting;
data containing information on arrival, expenditure and return of monetary funds intended for voting preparation and implementation;
information on termination of the election campaign;
information on termination of the powers of an official and/or authority;
information on granting the powers to the elected official and/or authority;
information submitted in accordance with a prescribed list of information given for the future open access to mass media and/or acceptable visualization tools;
information submitted in accordance with a prescribed list of information submitted for future display on sites of the Internet network;
information on the operation of the soft/hardware elements of the automated system and communication facilities and on the results of monitoring their status and service with a possibility of displaying the information contained in said blocks on a display.

According to the invention, it is also expedient that the data containing on the regulatory legal acts, regulating activity on the voting preparation and implementation at least include:
voting type and purpose;
   voting region and its division into administrative-territorial sites for voting preparation and implementation;
date and time of the beginning and end of the voting preparation procedure;
date and time of the beginning and end of the voting;
criteria on estimation of the selection variant for its registration as a variant given for voting in the voting region and/or its voting sites;
voting resources rendered to the voter for realization of his/her selection rights;
voter identification parameters;
criteria for recognizing the voter as registered for voting purposes;
criteria for recognizing the bulletin filled by the voter as valid and for the selection being made;
criteria for recognizing report of the site of the voting network on the voting results as valid;
criteria for recognizing the voting as implemented;
indexes assigned to said type of data for their identification in the common database information content.

According to the invention it is expedient that the data on the operation of the central control station and territorial sites of the voting network carrying out the activity on voting preparation and implementation comprise at least:
regulatory legal acts regulating their action;
functional features of said sites, their interaction, and a hierarchic structure of the voting network;
prescribed forms of accounts and reports;
information on the personnel;
a scope of rights given to the personnel for carrying out their activity;
information on special identification indexes assigned to each of the elements of the system, which must be included in the volume of the information block generated by said elements for input into said common database and/or for transfer to other elements and/or automated system, and allowing said automated system to identify the data source and its accessory;
data generated in the course of the voting preparation and forming voting documents including accounting documents;
information generated by the element of the automated system in said data blocks containing information received by the system in the course of the voting preparation and implementation, and providing a possibility of its display in the form of a text and/or graphics and/or digits and/or a table;
date and time of the voting beginning and end.

It is reasonable that in the system according to the invention the data containing information on the administrative territorial division of the voting region include a graphic image of the voting region map with indication of the boundaries of division of the region into voting sites with a possibility of detailing the site parameters.

In addition, in the system according to the invention the data on the object to be included in the number of selection variants for voting comprise at least the following:
parameters allowing one to identify an object of a supposed selection among the other supposed selection objects;
a data necessary for conduction by the voter of comparative estimation of the selection variants;
data registered according to the requirements of the regulatory legal acts for selection variants submitted for voting, in the scope of data necessary for conduction of comparative estimation of the selection variants;
information on the selection variants which have been given up in registration, and the reasons of such a refusal.

Besides, according to the invention the data on a prospective voter comprise at least the following:
data on the person who has reached the age of legal capacity for voting residing within the administrative-territorial site of the voting region allowing the system to identify him among the other persons living in this area,
data on the voting process participant necessary and sufficient for his identification among prospective voters,
a list of prospective voters reached the age of legal capacity for voting and living in one of the administrative-territorial sites of the voting region,
data on the person who has reached the age of legal capacity for voting who expressed a desire to vote at a voting site which is not his residence place,
data of the documents given to the voter by his request for voting at a voting site which is not his residence place.

According to the invention, in the system a voting object is selected from the group including a referendum, presidential elections, a higher official election, election of the head of a municipal union, elections of the head of an administration, election of a deputy, a recall of a person from an election post, a recall of a deputy, and the system has a structure of interaction of the system elements among themselves and with external elements corresponding to the voting purpose and to the voting region.

Besides, according to the invention, the system is adapted for the voting support whose type is selected from the group including direct voting and correspondence voting.

In addition, according to the invention, the voting region may be selected by the system from the group including a state, a federal union, a Federation subject, a municipal union, an administrative-territorial site.

In this case, according to the invention the voting preparation and implementation in one voting region are performed simultaneously for the several voting objects at any combination of the voting objects and types.

In so doing the system according to the invention can be adapted for voting for referendum, a recall of a person from an election post, a recall of a deputy, the selection variant being an answer to at least on one question, the bulletin has at least two selection fields for an answer to one question, and the answer is recorded in the bulletin by introducing a marker element in one of the two selection fields.

Besides, the system according to the invention may be used for voting for purposes selected from the group including presidential election, a higher official election, election of the head of a municipal union, election of the head of an administration, election of a deputy, in which case, when creating a common database of an automated system, additional data blocks are generated, which include:
data on registration of an election campaign with assignment to it a special coded index which must be included in the data blocks concerning the voting preparation and implementation for the selected purpose, and allowing one to identify such information in the common database information content;
information on the beginning of the election campaign;
information on the beginning and end, and on the content of the agitation campaign;
information on the termination of the election campaign;
information on the termination of the powers of the official and/or authority;
information on granting the powers to the elected official and/or authority;
data on the election collectives including political parties and/or election blocks and/or initiative groups of voters slating a candidate including:
   information on the involvement of said election collectives in election campaigns;
   information on the authorized representatives of the election collectives;
   data on the candidate slated by the election collective including data on his property and income;
data on the authorized representatives of the candidate;
data on the documents given to the registered authorized representative;
data on the candidate;
data on the arrival and expenditure of the money resources of the election funds of the candidates and on the obtained budgetary funds including for free broadcast time and printing areas;
data on registration of a candidate to be included in the voting list as a voting object;
data on the documents granted to the elected person;
the results of monitoring the legitimacy of the donations;
the results of checking the data on the candidate property and income; and in addition the automated system being also used for forming and granting registration documents to the candidate and for forming and granting to the elected person the document on his election.

According to the invention, the elements of the automated operational information system may be arranged at places of allocation of the voting network elements.

Besides, the voting network according to the invention may have a multilevel structure according to the established administrative territorial division of the voting region and hierarchy of its elements.

According to the invention, it is expedient that the parameters of identification of a voter such as a surname, a name, a patronymic, a date of birth, a birthplace, a residence or registrations and a document proving and identity card.

Besides, the system according to the invention provides the user with information in the form of data blocks to be displayed on a computer display and including:
a data block containing an index identifying this user;
   a data block containing information permitted for access by the user authorized for this access;
a data block for open acquaintance.

Besides, the system according to the invention gives to the user in a real-time and/or session mode an image of the information on the voting preparation and implementation on an appropriate cartographic image of the territory and/or areas of an administrative territorial division of the voting region and/or the voting region as a whole.

### BRIEF DESCRIPTION OF THE DRAWINGS

The invention is further described by way of examples of possible embodiments of realization of the automated operational information system according to the invention with reference to the accompanying drawings, in which:

FIG. 1 is a block diagram of the client-server architecture of the central element of the automated operational information system according to the invention;

FIG. 2. is a block diagram of the client-server architecture of a regional element of the automated system according to the invention;

FIG. 3 is a block diagram of the client-server architecture of a territorial element of the automated system according to the invention;

FIG. 4 is a block diagram of the input and output information on a subsystem of the automatic election processes of the automated system according to the invention;

FIGS. 5, 5a are a block diagram of the information flows in the automatic election processes at simultaneous election of the President of the Russian Federation and a federal referendum;

FIGS. 6, 6a are a block diagram of the information flows in the automatic election processes at election to the State Duma of the Federal Assembly of the Russian Federation;

FIGS. 7, 7a are a block diagram of the information flows at automatic election processes at election to a regional legislative authority (for election system 1,3,5);

FIGS. 8, 8a are a block diagram of the information flows at election to a regional legislative authority (the election system 2,4 is combined with election systems 1,3,5);

FIGS. 9, 9a are a block diagram of the information flows at simultaneous election to a regional legislative authority, a chief executive of the region and implementation of a regional referendum;

FIGS. 10, 10a is a block diagram of the information flows at simultaneous election to a legislative authority of a territory, a chief executive of the territory and implementation of a territorial referendum;

FIG. 11 is a block diagram of the information flows at implementation of a regional referendum;

FIG. 12 is a structure of the Service software complex of a maintenance and service subsystem of the automated system according to the invention;

FIG. 13 is a structure of a process control and monitoring subsystem;

FIG. 14 is a layout of the components of the process control and monitoring subsystem;

FIG. 15 is a functional diagram of the process control and monitoring subsystem,

FIG. 16 is a block diagram of the information flows providing monitoring of the technical state of the local computer network of the complex of automated resources of the central electoral commission;

FIG. 17 is architecture of the Service software complex of the maintenance and service subsystem;

FIG. 18 is architecture of the Service-Manager software complex of the elements of the automated system according to the invention, i.e. the complex of automatic resources of the electoral commission;

FIG. 19 is a scheme of the information flows when monitoring the processes;

FIG. 20 is a scheme of operation of the automated operational information system according to the invention at election on a federal level.

The above examples of performance of the system according to the invention are not beyond the scope of the patent claims and do not limit the possibilities of application or modification of the invention.

### THE BEST EMBODIMENT OF THE INVENTION

The system according to the invention can be used in election campaigns at various levels, in different voting regions having a different territorial extent and a various number of voters in the voting regions. For example, the system can be used both for presidential election and for election of officers at various regional derivations.

In this case, the automated system can be formed again either using the available territorial structural network of the elements possessing the described above possibilities of the system elements according to the invention or its part while keeping the interaction of the necessary peripheral elements of the system with the central element and the database of the system.

In so doing various information resources may be used, for example, the information on a regulatory legal character relating to the common legal rules, to electoral registers which, according to the invention, are maintained by the system in an actual state.

Besides, the system according to the invention can be used simultaneously for preparation and implementation of several election campaigns and referenda both in one voting region, for voting in the same day, and in different regions of different campaigns simultaneously at voting at different time.

In the automated system according to the invention having the territorially-distributed structure of elements the layout of the system elements may coincide with places of accommodation of the voting network or may be different.

The system according to the invention may be described on an example of its application for election campaign on the territory of the Russian Federation, in particular, election campaigns of a federal level, as well as campaigns of regional and local scales.

In so doing if the organizational structure of such an election campaign and a voting network according to the legislative and normative acts is a multilevel structure presented by several levels of elements, the structure of the automated system according to the invention organized for solution of functional tasks of support, preparation and implementation of such campaigns will also be multilevel.

The architecture of the operational information system according to the invention may be illustrated on an example of an embodiment of its use for the state automated system of the Russian Federation (SAS).

The SAS system is structurally multilevel and includes computers, networks, applications, processes. The different levels are relatively independent but they are closely linked to each other. By interaction between the elements at various levels in the system, a plurality of services and functions of the operational information system is realized. Each level has its own agents for controlling and monitoring this level. At movement on the hierarchical levels upwards a certain scheme of controlling interactions is formed.

In so doing the elements of the automated operational information system according to the invention set up an automation complex arranged at electoral commission of different levels.

The elements of the automated operational information system according to the invention comprise automation equipment complexes (AEC) and soft/hardware means (SHM), for example, personal computers equipped with hi-tech operating systems, such as Windows Microsoft and DBMS Oracle providing realization of a common technology of data acquisition, processing, accumulation, storage, search, reception/transmission and distribution, and special applications realizing the tasks of complex automation of all major processes.

The architecture of the elements of the automated system according to the invention represents automatic equipment complexes (AEC) that may be different.

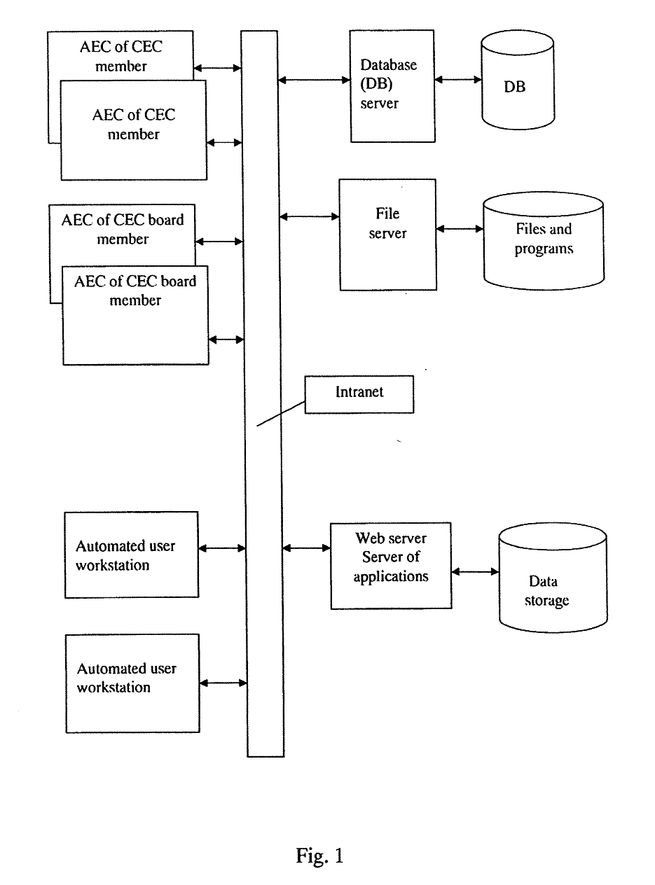

For example, as shown in FIG. 1, for the central electoral commission (CEC) is a two-link client-server architecture of a professional category providing implementation of election campaigns using automated election technologies, and a three-link client-server architecture for users having an access to the information only in a review mode, for example, using report generators such as Crystal Report with an application server of Crystal Enterprise. In this case, the CEC members are connected via the Internet with the database servers (DBS) and data storage units, and the computer workstations at a place of allocation of CEC are connected to the servers of the applications databases.

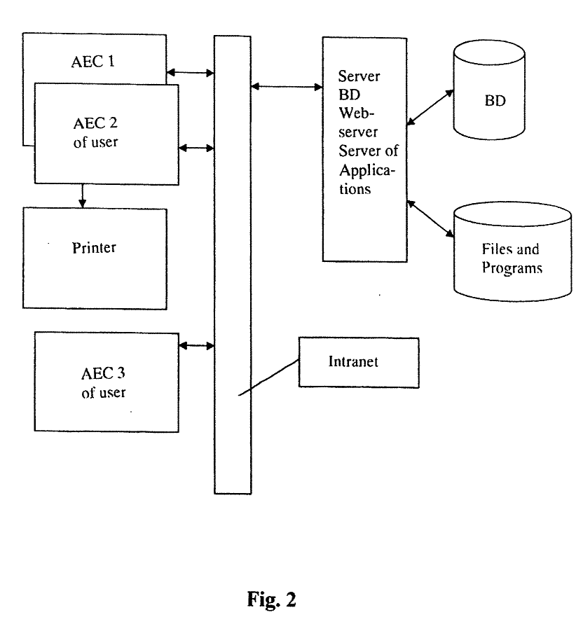

For example, as is shown in FIG. 2, for the AEC of the electoral commission of a subject of the Russian Federation (ECSRF) is a two-link client-server architecture, in which the computer workstations at places of allocation of the ECSRF are connected to the DBS servers through the Intranet network, DBS applications and Web-server.

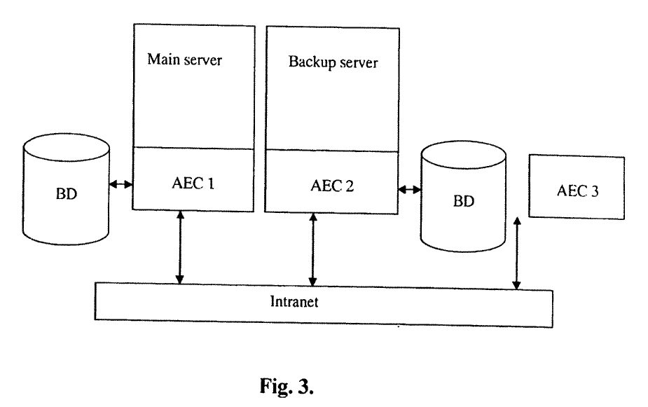

For the AEC of other electoral commissions an optimal solution is a two-level architecture, in which a multi-user database control system (MUDCS) combined with an automated working station (AWS) operating in a peer-to-peer network. The reliability can be increased using a back-up server for the DBS (FIG. 3). In this case the MUDCS software, for example, SQLBase is installed on two computers of the peer-to-peer AEC network. In so doing on the main server is provided with a DB, and the back-up server stores the directory of the DB copies.

The SAS system is made territorially distributed and, therefore, the data needed processing can be formed and entered at the same places and elements of the system, for example, at the complex of automatic resources of territorial electoral commission (AEC TEC), to be processed in other places of the system, for example, the AEC electoral commission of subjects of the Russian Federation (AEC ECSRF) and used at a third place, for example, in AEC of the Central Electoral Commission of the Russian Federation (AEC CEC), and to be used in third places, for example, in the AEC the Central electoral commission of the Russian Federation (AEC CEC). The use of the distributed processing at input, updating and removal of data allows one to reduce the load of the server and to use the total AEC capacity more effectively.

The information systems may be based on various architectures of a different configuration, for example, a client-server may be used. Their core is a multi-user system for database control (MUDBCS), performing the functions of server of a database (DB). The server is primarily intended for storage, transfer and sharing information between the clients. A client in such a configuration is an automated workstation with a graphic interface to access applications.

The interaction between the AEC ECSRF and AEC TEC and AEC of the district electoral commission (AEC DEC) is carried out via a switched telephone communication channel. The interaction between the AEC CEC and the AEC ECSRF is effected through dedicated communication channels, and the information exchange—by means of the DIONIS mail system.

The SAS system in a real-time mode provides operation of the following subsystems:
functional subsystems:
subsystems used for automation of election processes supporting the activity of the electoral commission of all levels according to the acting regulatory legal acts,
subsystems of registration of voters, referendum participants, providing data in a digital and graphic mode and automated creation of electoral registers of local electoral commissions,
subsystems for automation of the administrative activity of electoral commission providing logistics management and document circulation of all electoral commissions,
reference subsystems based on the WEB sites and Internet technologies to provide the user access to information resources of the automated system according to the invention and a display of information in a text, cartographic, digital and tabulated form,
the Internet portal subsystem providing operative presentation of information on the course of the election campaigns, on the voting process, on the preliminary and final voting results, and on the activity of electoral commission of all levels at realization of campaigns of federal, regional and municipal levels,
subsystem for large-format display of multiple access information providing control of submission of information from the SAS databases, realization of video conferences and television bridges, realization of TV shootings, and providing operation of the following subsystems:
subsystems of link and the data transfer providing by means of a collection leased and dial channels of a network of telephony of common use, knots of switching and subscriber knots of access transmission of all demanded types of the information traffic between the subscribers and information bases of automated system,
subsystems for controlling and monitoring the operation of processing the functional information monitoring of the operation of SHM/AEC devices and information protection devices, monitoring of the state of other subsystems of the automated system,
subsystems for maintenance and service of the AEC of all levels providing testing and software duplication, creation of reconfiguration models of regional fragments of the automated system for implementation of several elections simultaneously, software installation, updating the complexes of automatic resources of the automated system according to the invention, and for other tasks,
subsystems providing information security, verification and delimitation of authority of the users, monitoring attacks from external sources, cryptographic protection of information flows, and virus protection,
subsystems for personal training, providing education and training of users and service personnel, including remote training, to operate the automated operational information system according to the invention,
finance managing subsystems providing automation of the planning and financing activity and book keeping at the electoral commissions.

The SAS system provides operation of all SAS subsystems when conducting all types of election campaigns prescribed by the legislation:
referenda;
election to a post;
election of deputies of a collegiate body including a legislative or power body or a local government representative body;
recall from an election post or a recall of a deputy.

The support, preparation and implementation of election of deputies are possible using five election systems identified in the SAS by digital codes:

1 election by a plurality of majority one-mandate or multi-mandate districts;

2—election in a district by a proportional system;

3—election by a mixed system;

4—election by a majority voted system;

5—election by a mixed system.

The vertical information interaction is established depending on the type of election between the SAS levels. Each level is determined by a configurator of the soft/hardware means.

The SAS system is adapted for operation in two modes: main mode and training mode. Each complex of automatic resources has two databases are established: one is real used in the main mode, and the other is dummy used in the training mode.

In the operating mode at preparation, realization and summation of the election or referenda at a federal level the whole SAS system operates continuously round-the-clock. At preparation, realization and summation of the election or referenda at regional or municipal level individual fragments of the SAS system operate continuously round-the-clock.

In the intervals between election campaigns the SAS may be used for information service of federal, regional or local authorities.

The users of the SAS system represent a common single interface. In the SAS use is made of a single system of classification and coding.

The operation of the SAS subsystems is run using software written according to the functional tasks of the subsystems and providing interaction of the subsystems among themselves and with the databases, and interaction of the databases among themselves and with the voting resources.

The information representing the result of operation of whole subsystems of the automated system according to the invention is published on a Web site in an approved output format.

The SAS system operation is provided by interaction of all above-described subsystems. The constructive and soft/hardware support of the SAS as a whole and its subsystems can be made on the basis of well known software and hardware means providing performance of the tasks of the subsystems and of the SAS system as a whole.

The operation of the SAS may be illustrated on an example of realization of some subsystems of the SAS system.

The Subsystem of Automation of Election Processes (SAEP) Provides:
data entry, including input, updating, removal and review of data using a display;
batch entry of some types of data from files;
data processing;
creation of reports and election documents;
generation of messages to be transmitted and processing of messages received through communication lines;
user requests processing for the purpose of information retrieval under various search conditions.

The level of automation of the processes of the voting preparation and implementation depends on the type of an election campaign, a role of the electoral commission in it, voting type (primary or repeated voting), and a level of realization of the campaign.

The electoral commission role is determined by the position of the commission on the tree of territorial-election division (TED), created when conducting each election campaign.

The TED functions are associated with the electoral commission role. For example, the commission role may be organizing, transferring, registering (for example, a district commission) or another.

The SAEP subsystem functions at the AEC electoral commissions with a hierarchic subordination structure. The number of users of the subsystem in each individual AEC varies. At the AEC of regional and local levels the subsystem can operate with several workstations, at the AEC of the CEC the number of workstation is determined by a volume of the processed information including input, removal, updating, and removal of the DB data, review and analysis of information.

When conducting election campaigns, the SAEP provides combination of campaigns of the federal, regional and municipal levels, as well as teamwork of several electoral commissions with the same complexes of automation resources providing sharing of information flows and data processing by the election types.

For storage of current and retrospective information a database is used, which operates under control of the MUDBCS multi-user system providing operation in the client-server architecture.

The Input Data of the Subsystem for Automation of Election Processes Include:
data entered by means of a keyboard and a display;
messages received via e-mail or read from magnetic disks;
data from a database;
data as a part of files intended for batch input;
data in a request forms;
parameters of creation of reports;
data received from the automation resources of local electoral commissions, for example, from a machine for voting and processing the voting results.

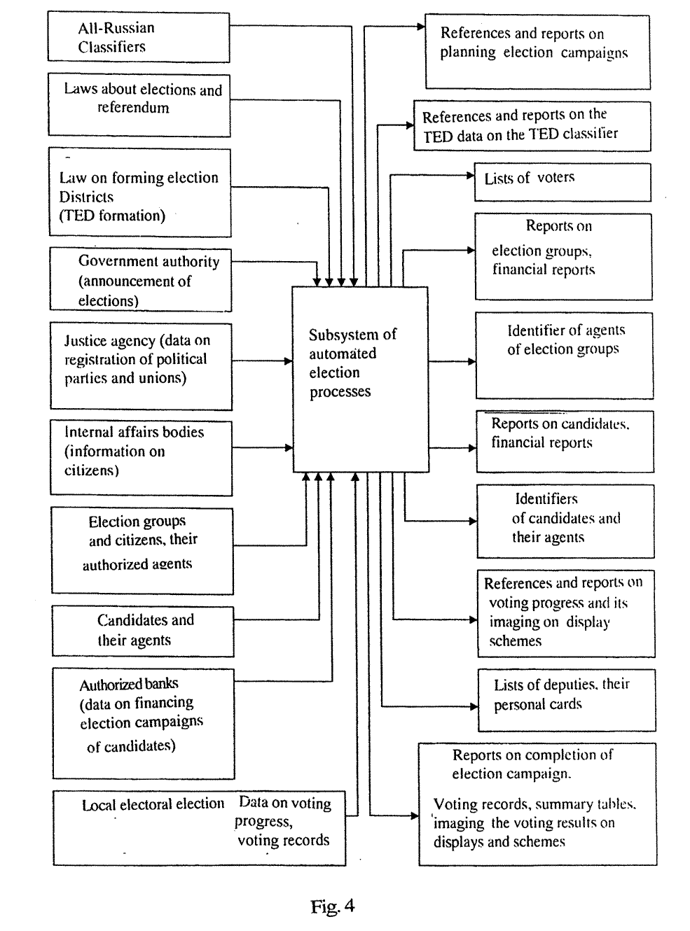

As shown in FIG. 4, the input data of the SAEP subsystem is information formed:
on the basis of the data of all-Russian classifiers and dictionaries determining the unity of terminology and a conceptual apparatus of election processes;
on the basis of regulatory legal acts, for example, the Law of the Russian Federation on election and implementation of a referendum, the Law of the Russian Federation on forming election districts;
on the basis of the information from the authorities of the Russian Federation, judicial authorities of the Russian Federation, bodies of the Ministry of Internal Affairs of the Russian Federation, public associations and citizens, candidates, authorized banks, electoral commissions.

The Output Data of the SAEP Subsystem Include:
data stored in the database;
data displayed on the screen of a personal computer (PC) for review;
messages transmitted via e-mail channels;
reports on a PC screen, on a paper carrier or in the form of a file.

As shown in FIG. 4, the SAEP output data consist of the information, for example, formed:
on the basis of references and reports on planning election campaigns, on a territorially-election division of regions of the Russian Federations;
register of voters;
reports of election collectives including financial;
reports on candidates including financial;
lists of candidates and elected persons;
references and reports on the course of voting and their display on schematic maps;
reports on termination of election campaigns including protocols of voting and summary tables and image of voting results on schematic maps,

as well as information on certificates of authorized representatives and of the authorized representatives of election collectives, certificates of the candidates, their authorized representatives and authorized representatives, certificates of the elected persons.

The functional structure of interaction of the AEC at a hierarchical level used in the SAS, in the SAEP is provided by complexes of target programs (TP):
the <<Election process>> TP unifying the software providing implementation of election campaigns of all kinds and levels, reception of the voting results and the results of an election campaign as a whole, and including programs: “Planning”, “Electoral Commissions”, “Candidate/Deputy”, “Totals”, “Agitation”, “Shell”;
the “Legislation” TP providing legal information in the election legislation sphere, submission of regulatory legal acts;
the “Voter” TP for conduction of registers of voters, their analysis and checking for the presence of doubles;
the [symbol] Finance Management [symbol] TP to control the election funds of the candidates and election collectives;
the “Cartography” TP for delimitation of election territorial divisions, as well as of an image on cartographic background of the information on the election campaigns, the course and voting results;
the “Classifier” TP for the centralized conduction and dispatch of public classifiers, linear dictionaries and references used for semantic control of entered values and allowing one to store their codes instead of their values that leads to reduction of the volume of the stored information.

The packages of programs can be adapted for solution of other tasks of the subsystem. Programs can be improved with development of the SAS system and the extension of its functional tasks.

For example, the “Candidate/deputy” program provides automatic acquisition, registration and submission to users of the following data:
by registration of election collectives: election blocks, election associations, initiative groups of voters;
on drawing lists of candidates put forward by them;
data on signatures in support of the candidates, on checking the authenticity of the signatures;
by the results of a toss-up for determining an order of allocation of the candidates in the voting bulletin;
by creation of make-up pages of voting bulletins;
by the voting results;
by preparation of registration certificates and other documents on the course of preparation and implementation of an election campaign, as well as results of statistical processing of data according to desirable parameters of sampling including comparative statistical processing of data of various election campaigns.

For example, the “Agitation” program provides control of the pre-election campaign conducted by candidates or election collectives, registration and checking violations of the election legislation. This program also carries out registration of the poll results, controls the conditions of access of registered candidates and election blocks to mass media, conditions of conduction of mass actions, conditions of release of printing, audio-visual and other agitation materials, as well as reveals abuses using the Internet network, and provides control of expenditure of funds for agitation, for example, together with the [symbol] Finance Management [symbol] TP.

For example, the “Shell” program is used for support of the operation in a session, for transmission and reception of messages, as well as for installing in the automated operational information system of various programs and creation of databases. In so doing the following is provided:
entry a session with user identification and selection of a mode of operation—working or training;
forming a menu of the head screen of the session taking into account the user category;
forming a list of election campaigns, supporting a search in this list and providing an access for operation in an election campaign in the list;
forming a menu of election actions;
call of program modules corresponding to the points in the menu;
administration of operations on the automation equipment: registration of users and assignment some rights to them, adjustment of the parameters of operation of the automation equipment and computer workstations, switching of the modes: working and training;
copying of a current election campaign from the main database into the training one with replacement of the real information on the candidates and election collectives by the conditional test information;
information exchange between the DB of different AEC via e-mail channels, for example, using the DIONIS multi-user electronic center of communication services, a call to which is made by calling the transport module TM for Windows;
copying the programs TP of the subsystem of automated election processes from a carrier, for example, a compact disc to a file of the AEC server, installation of the main and training databases, adjustment of the user computer workstation.

The fundamental information with which the “Legislation” TP operates is the electronic text of the regulatory legal acts (RLA), for example, in the form of a file in the Word text editor in the ASCII format and a registration form RLA displayed on the PC screen by the user or in the course of automation linguistic processing of the RLA text. The “Legislation” TP provides operation of the AEC, for example, of the central electoral commission of the Russian Federation and electoral commission of subjects of the Russian Federation, in which case the “Legislation” TP can be run by well known devices, for example, the Centura Team Developer processor.

The [symbol] Cartography [symbol] TP provides automatic mapping, input and editing of maps, a change of the cartographic layers of the election territories, division into election into voting districts and sites, output of subject information on a cartographic background, as well as creation, display and saving of sequence of the topic schematic maps. Besides, this TP provides preparation of presentations, election calendars and a state of the AEC on sites, generation of output forms on requests of users in a dynamic mode, operation with the archive of topic maps, demonstration of multimedia presentations.

In so doing the division into election districts and sites is made in an automatic and/or manual mode with monitoring of the process of division in the form of step-by-step dialogue. Selection of variants of division is provided both by a deviation from an average rate of representation of voters, and by mutual deviation of a number of voters in various districts with preset accuracy taking into account the predetermined criteria for an estimation of the best variant of division.

The topic information on the cartographic background from the data base of the automated operational information system may be presented in the form of lists, graphic diagrams or by color selection of cartographic fragments.

For example, at the step of preparation to voting, a total number of sites and listed number of voters are displayed. After the voting has been started, information is added on opening the voting sites, a voting course within a given account time, for example, on the amount of the cast voters. After the election is over, information is presented on the voting results, percent of the voices submitted for candidates, the <<against all>> poll. The dialogue of presenting the subject information may be built up under a selected display scenario.

The [symbol] Classifier [symbol] TP provides a centralized input of system-wide classifiers and dictionaries formed mainly in the AEC CEC and extended to the other AEC automated system. Entered in the AEC ECSRF are data on regional and local public associations. For operation with registers of voters, the AEC of various levels may be added with dictionaries of names and patronymics.

The AEC CEC are added with new values and codes of values, a feature “retro” to the values which should not be used more for coding, and are necessary only for decoding, review of the structure of the values and codes of values corresponding to them, as well as a unloading of the dictionary information in files for their transfer to others AEC. In so doing when unloading the hierarchical classifier two variants of the unloading are provided: an unload of the entire classifier or a certain hierarchical branch that is necessary, for example, for unloading a fragment of the classifier of administrative territorial division of the Russian Federation corresponding to a certain subject of the Russian Federation.

On all others AEC of the SAS system a review of the dictionary information including indication of the sorting scheme of values and their codes, as well as loading of classifiers, dictionaries and references from the files sent from the AEC CEC is provided.

For data storage each AEC uses a common integrated database controlled from the data base control system providing multi-user operation in a client-server, for example, the MUDBCS Oracle. An integration of information requirements in the common logical database structure is a basis for development at various references and reports, in which any type of information can be unified for analysis.

The information objects have a main primary key in the form of an identifier generated by the above mentioned [symbol] Election process [symbol] package of programs in the form of intersystem registration numbers (IRN). The IRN value is unique in the whole set of the system databases during the entire time of existence of the SAS. The input of the IRN in the structure of the DB tables allows one to reduce the volume of indexes, quick search including transfer between the DB tables to simplify the access to databases, for example, by using the SQL language which is the main international language standard for relational and objective-relational DB servers and creates a basis for integration with other control systems of information resources.

Each information object in a logical structure has special technological fields allowing one to register the information on the entered and updated data. This information may include the data input date and time, the identifier of the user who has made the input, as well as date and time of the last updating of the data and identifier of the user who has made the last updating. In addition, a possibility is provided to obtain data identifying the AEC as a source of the entered information, for example, information on the AEC manufacturer number on which there was made the initial input of a copy of the information object in the DB that is important for the case when the automated election process is carried out on a plurality of AEC of the system.

The BD structure includes a subsystem with tables simulating the meta-model of the SAEP subsystem combining the tables with the lists of all information objects, for which there are developed forms of data processing, all reports, requests, and messages and compositions of information objects therein, and their identifying codes.

The main structural component of the meta-model is a circuit of selective action for all kinds of election campaigns, election systems and roles of electoral commissions, on which basis there menus to access election operations are formed dynamically in the form of pop-up windows.

On the basis of a meta-model and the MUDBCS data dictionary, a possibility of addition of new attributes into the structure of information objects without changing the programs of reception and transmission of messages passing is provided.

In the integrated DB structure the concept of different roles, which are possible for the same electoral commission in various election campaigns with its involvement, is taken into account. For example, in the election of deputies of the State Duma of the Federal Assembly of the Russian Federation a situation is simulated, when on the territory of some subjects of the Russian Federation there is no district electoral commissions, and their role is performed by the electoral commission of some subject of the Russian Federation.

The user interface of the subsystem of automation of election processes is a general-purpose graphic interface meeting the modern requirements to this type of equipment.

For example, the structure of the head screen of a session may have a horizontal menu and an area in the center of the screen with a list of current election campaigns comprising columns with a level and a name of an election campaign, a voting date, and a date of a decision of finishing the campaign, as well as other data relating to the election campaigns. The interface allows the user to carry out the check the status of the election campaigns in a dynamic mode. The head screen menu of the subsystem provides access to information on the other SAS subsystems.

In Each AEC the User can Analyze Three Sets of Election Campaigns:
a current election campaigns accessible to operation therein in the list of the head screen of the session;
a current election campaigns organized in subordinate IR and sent as a part of messages for their review and analysis;
a completed election campaigns, data on which relate to retrospective information.

Selection of campaigns from the two latter sets is possible by request only.

For individual types of information requests are organized allowing one to obtain statistics on the most actual analyzed indices. A statistical index can be produced in the form of an absolute and percentage value.

For example, the “Statistics of the group of candidates>> allows one to obtain a large list of summary statistical data on the candidates for election to a post, in which the statistics of promotion of the candidates is combined with and their social set-up. For example, by the following parameters:
a number of slated candidates including men and women:
   from promoting subjects (collectives, groups and self-promotion);
   from deputies or elected officials;
   having two work places;
   having a previous conviction;
   having a dual citizenship;
   participating in election for the first time;
   specified belonging to a public association;
a number of candidates:
   registered:
      by a solution of an electoral commission;
      upon court order;
      after refusal in registration:
         a number of refusals in registration;
         a number of cancels of registration;
   candidates who have left the number of candidates before registration and after it.

In so doing a possibility is provided of construction of diagrams, for example, column-like or circular, and a list candidates corresponding to the statistical parameter.

In a review of the protocols of reception and transmission of messages, in addition to typical protocol characteristics for each message, the screen displays the name of an election campaign, the mailer name, the place of the AEC, from which the message was sent. The analysis of protocols by an individual campaign and the election as a whole is possible.

The addressing in transmission of messages under the election campaign is based on the addressing by the structure of a territorially-election division (TED). If several election campaigns are conducted in parallel, several addressing shames are by the amount of these campaigns taking into account the TED created for each campaign. The AEC CEC gathers the data on federal, regional campaigns and on campaigns for territories of subjects of the Federation. The AEC ECSRF gathers data on the regional campaigns and the local campaigns of any level conducted on the territory of any subject of the Russian Federation.

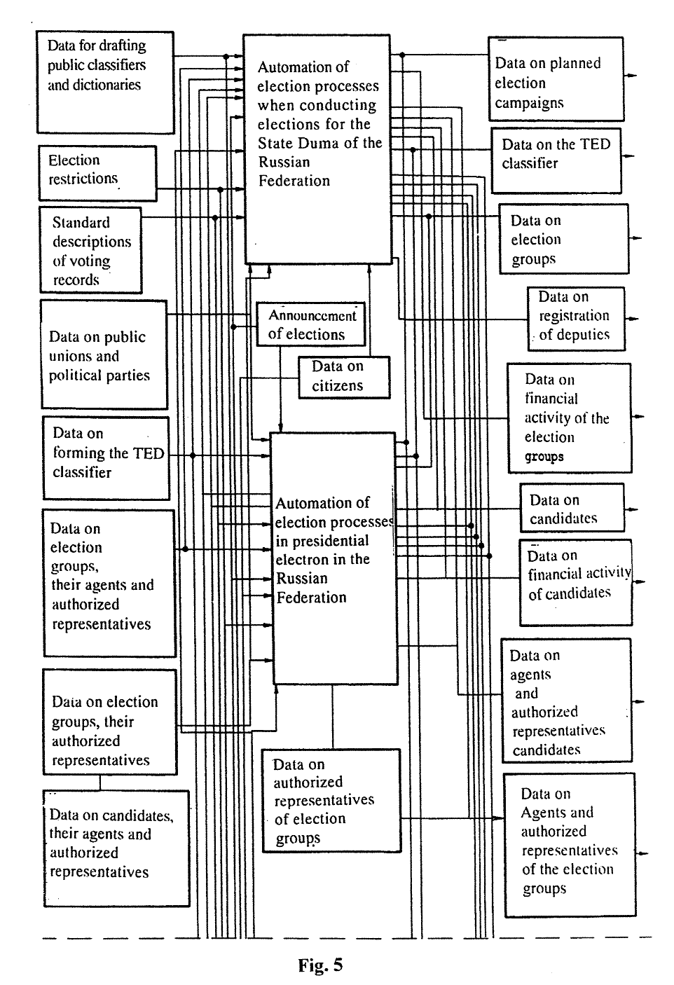

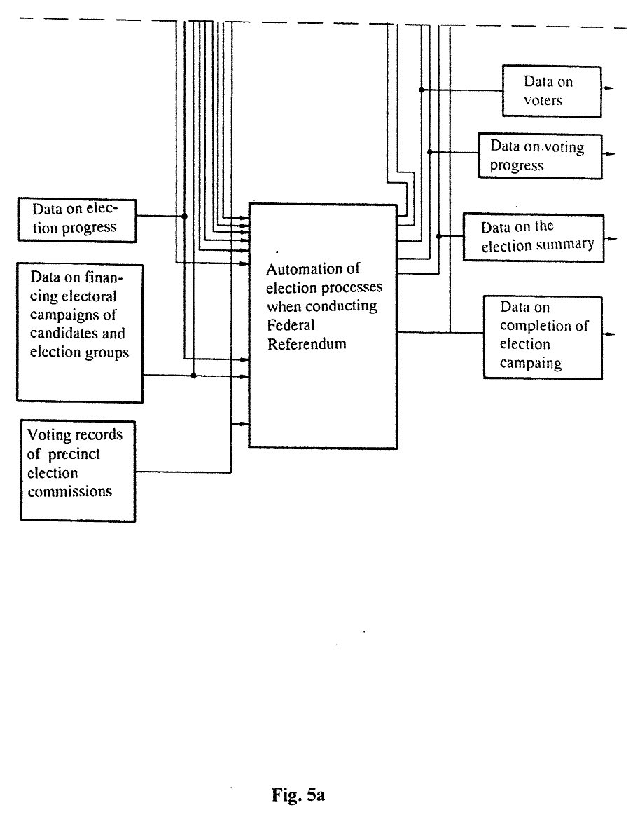

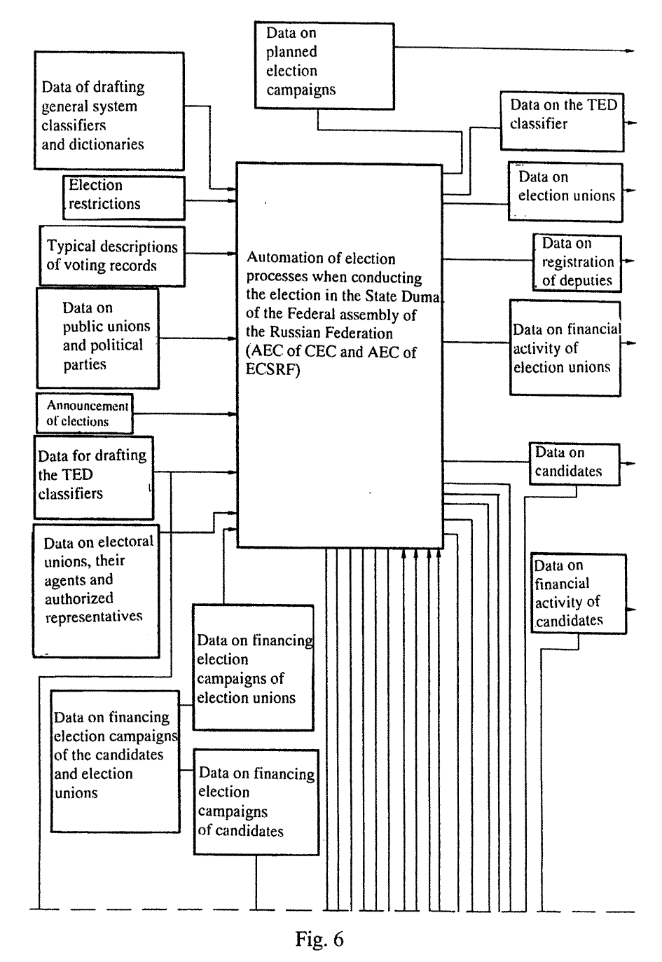

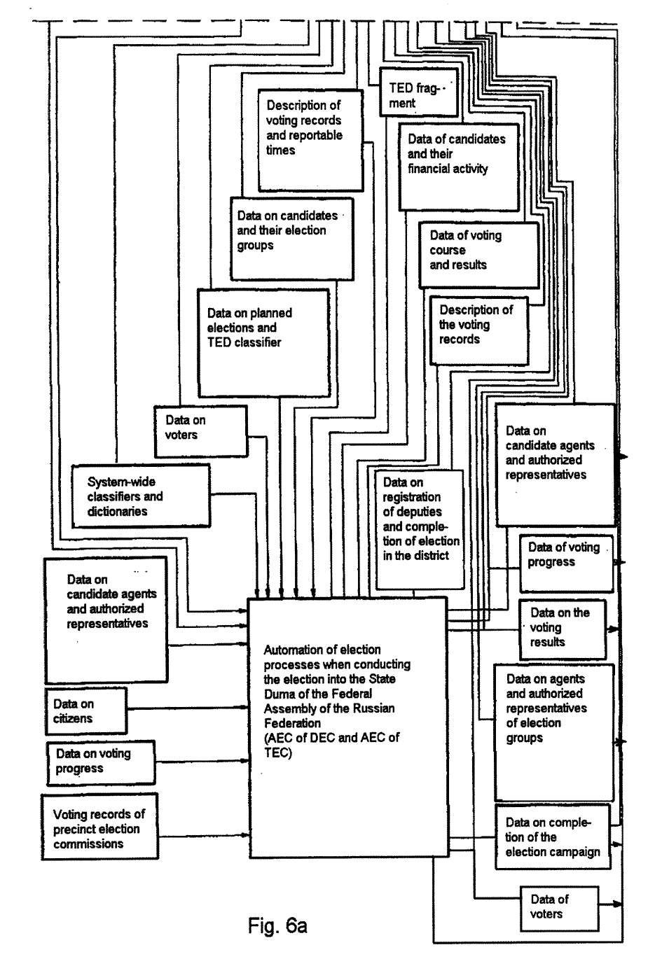

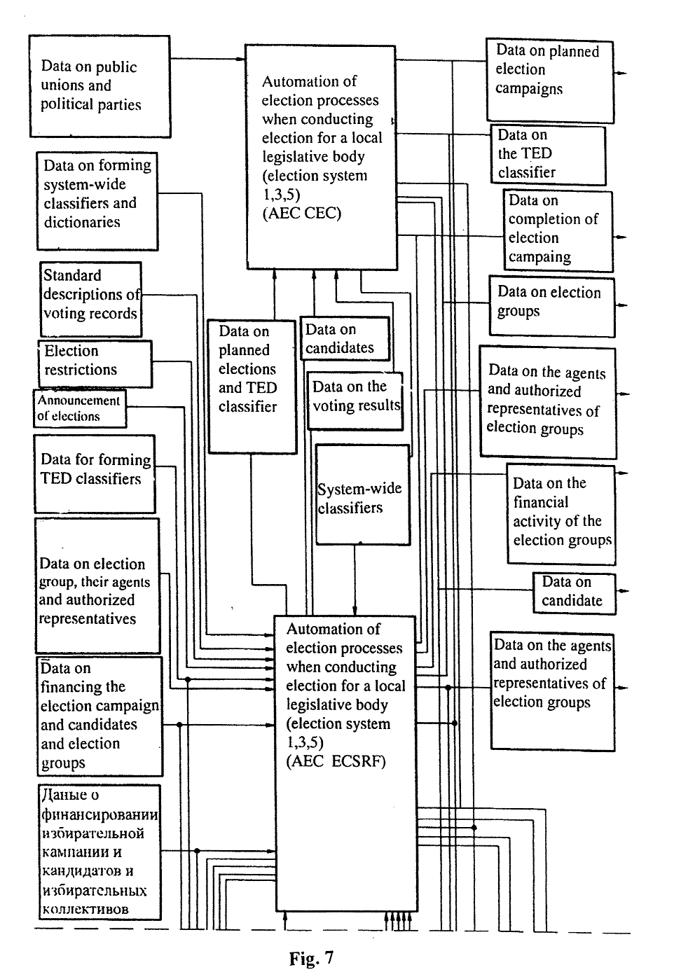

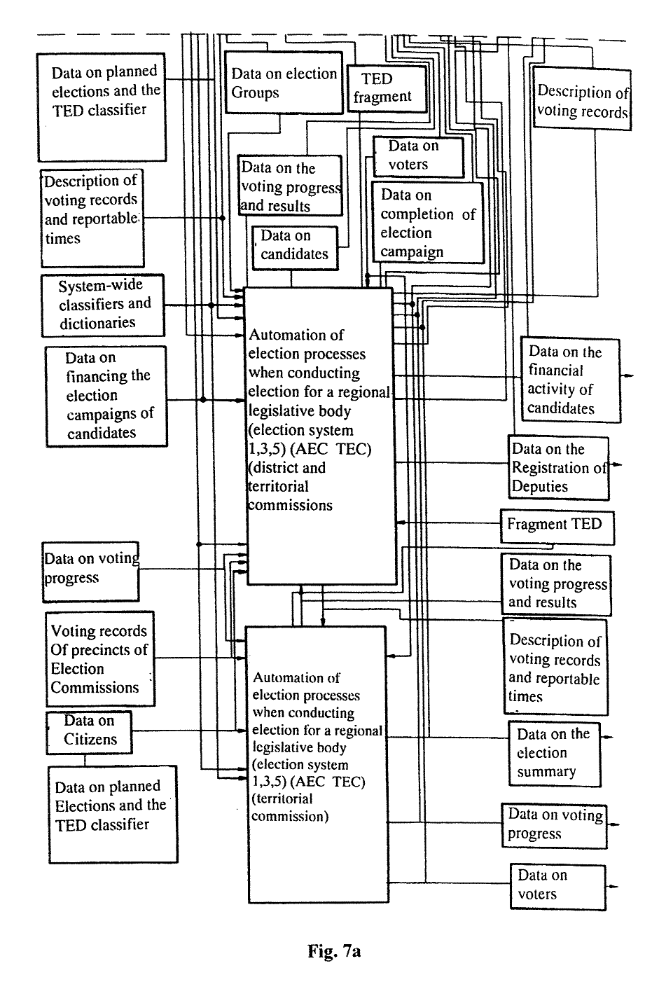

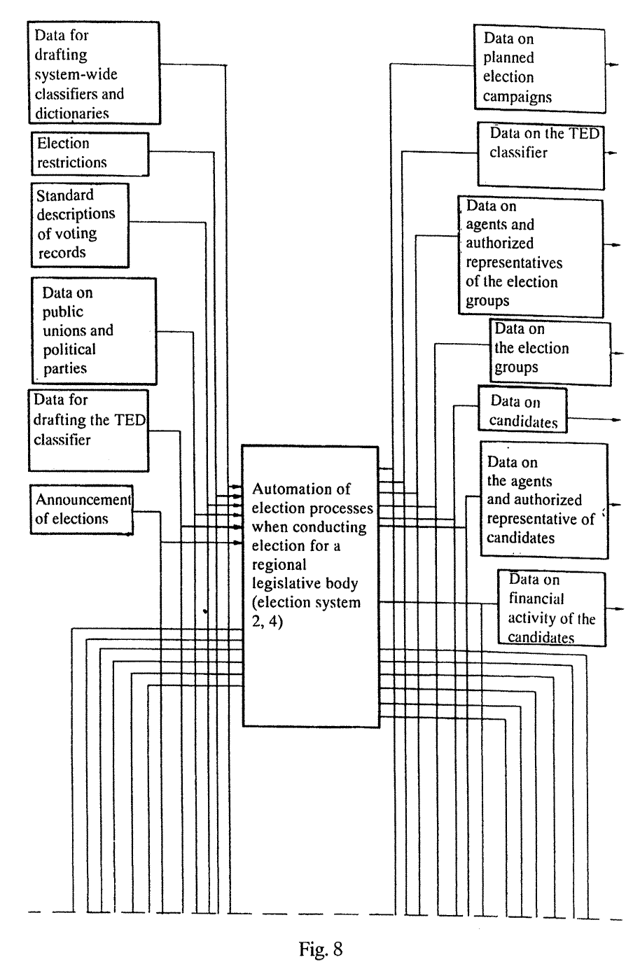

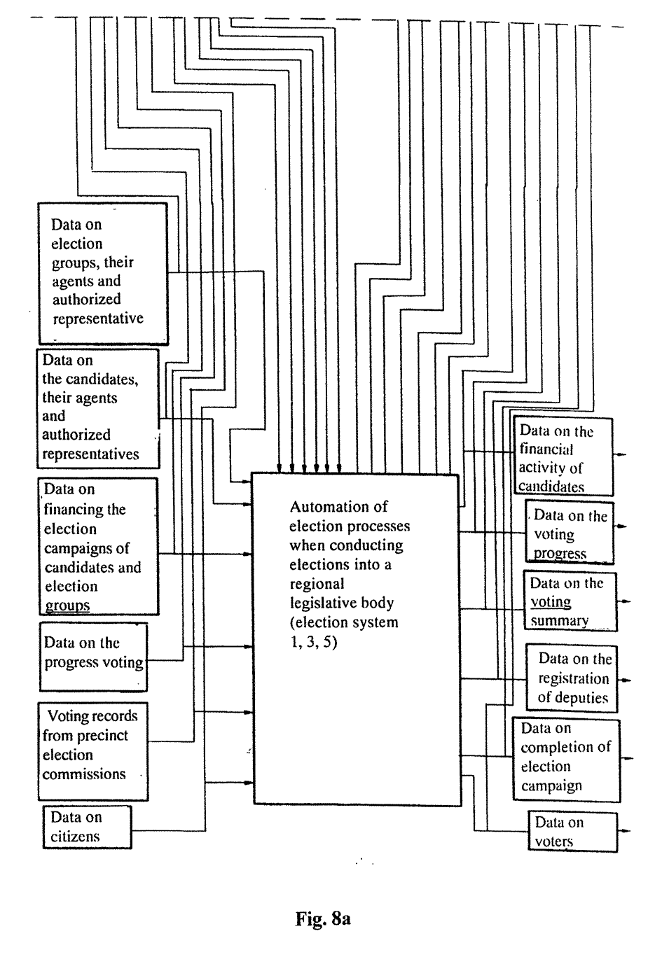

The diagrams of data flows realized in the SAEP SAS subsystem by automation equipment of different levels are provided by the electoral commissions: district electoral commission (DEC), territorial electoral commission (TEC), central territorial electoral (CEC) and the commission of subjects of the Russian Federation (ECSRF) are presented on examples of automated election processes at the simultaneous presidential election in the Russian Federation and the federal referendum (FIGS. 5, 5a), at election of deputies of the State Duma of the Federal Assembly of the Russian Federation (FIGS. 6, 6a) by the mixed election system: in a single district with a proportional system and in majority districts. Also when conducting the election to a regional legislative authority simultaneously on territories by the election systems in a plurality of majority districts and by the mixed system (FIGS. 7, 7a), and the same election at their combination simultaneously with district election by the proportional system and under the majority voted system (FIG. 8, 8a).

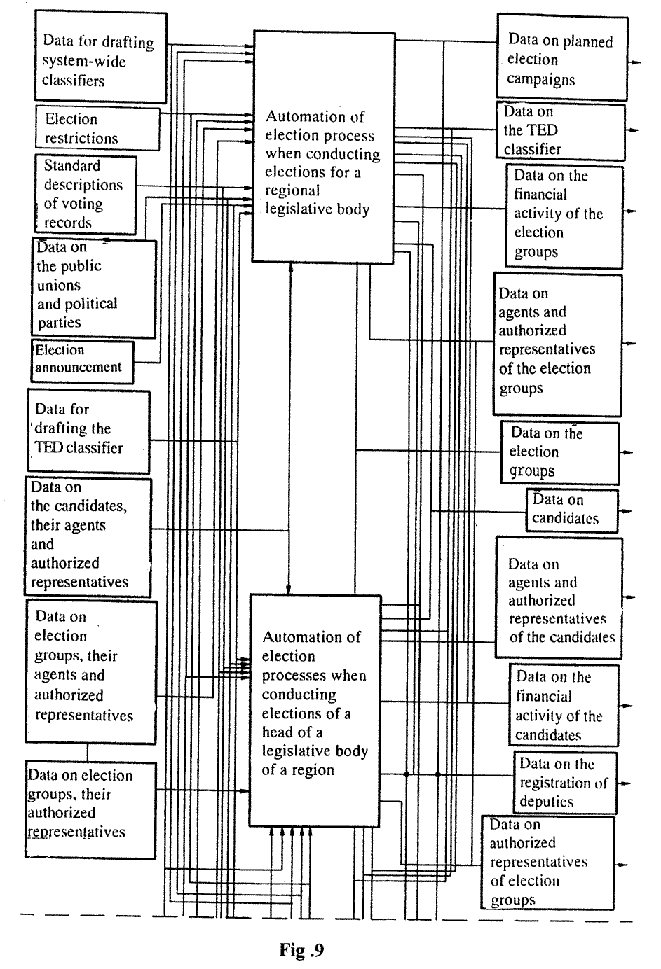

A diagram of the data flows at simultaneous election to a regional legislative authority, the chief executive of the region and implementation of a regional referendum is presented on FIGS. 9, 9a.

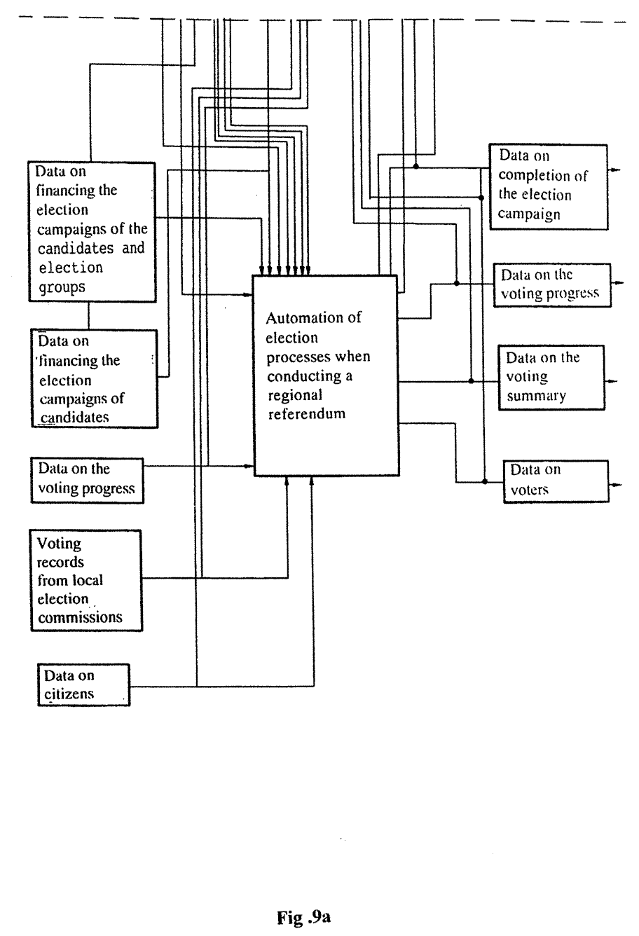

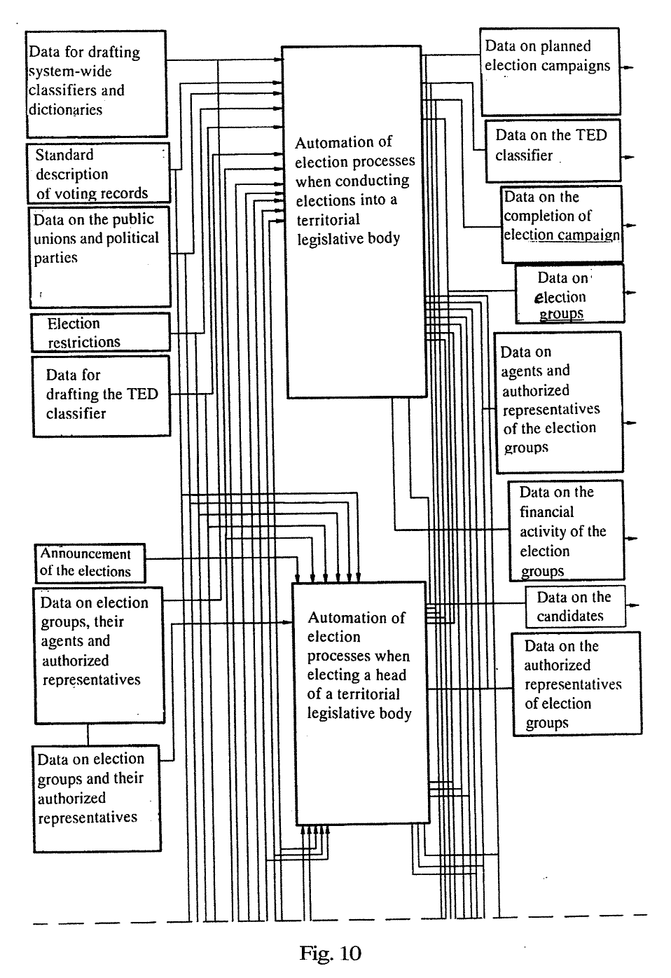

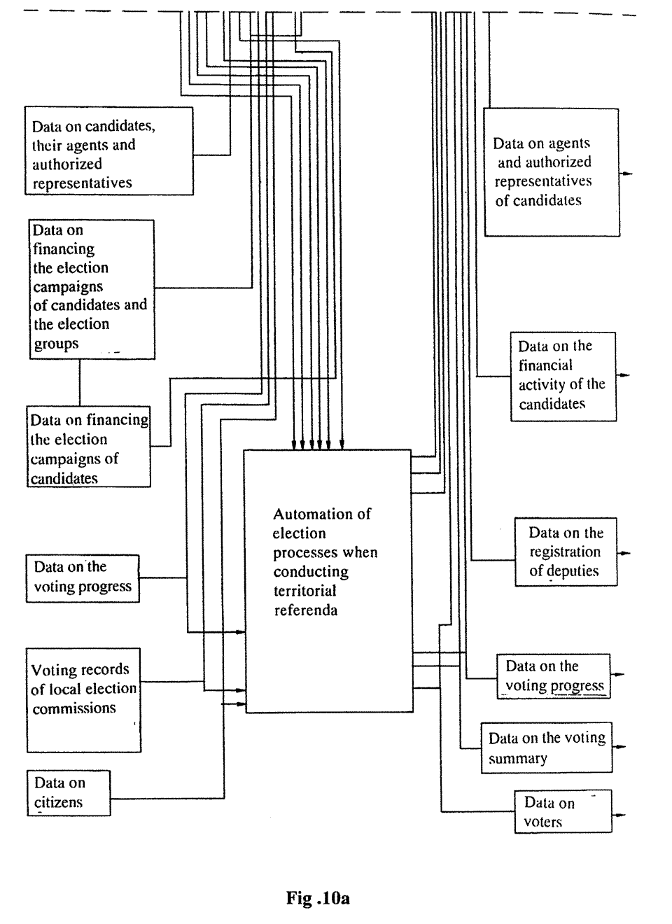

A diagram of the data flows, when implementing simultaneous election to a legislative authority of a territory and a chief executive of the territory, and implementation of a territorial referendum is shown in FIGS. 10, 10a.

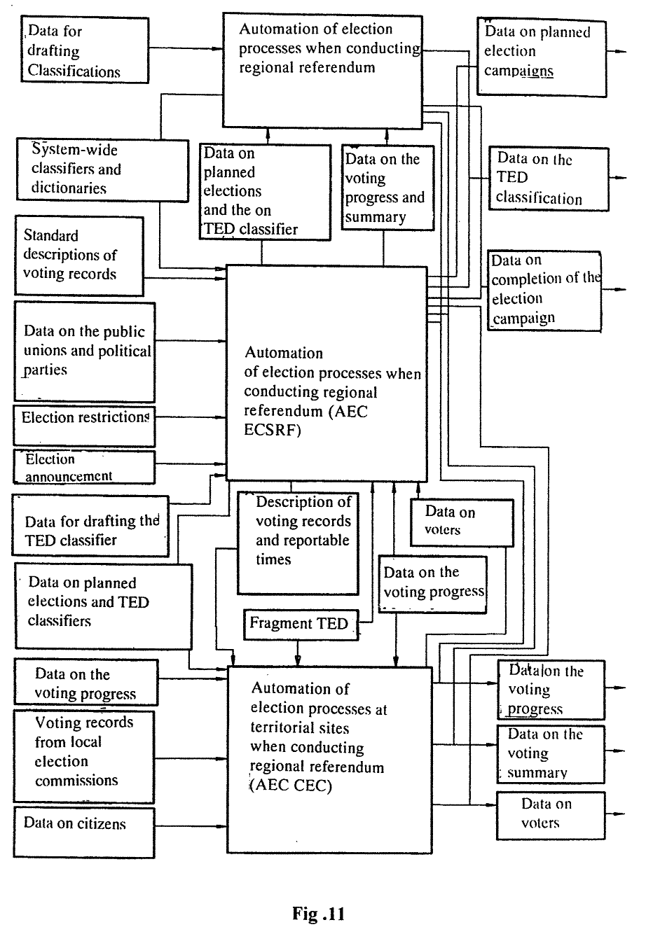

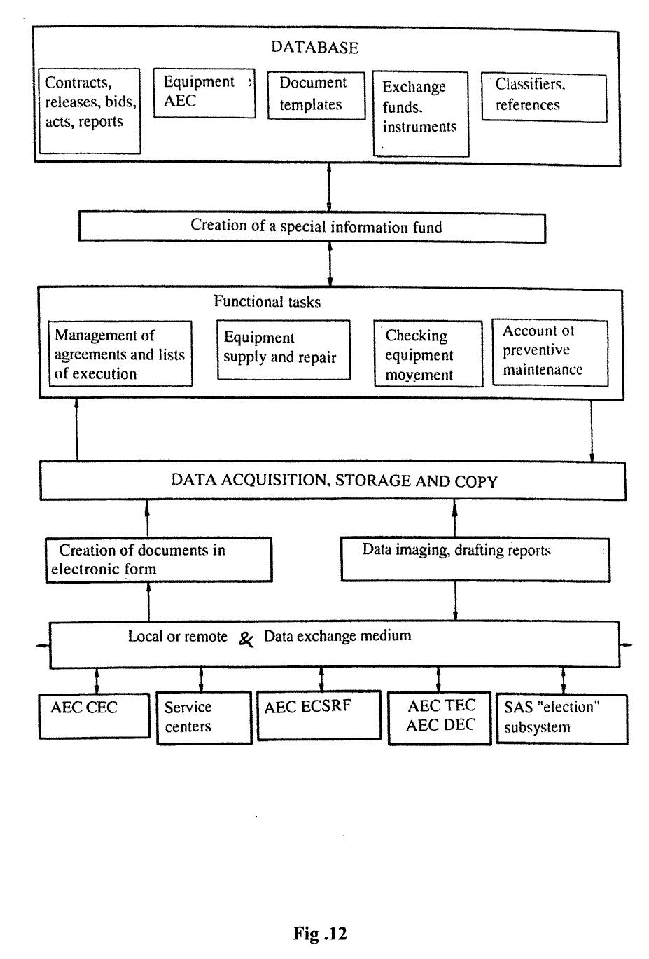

A scheme of automation of the processes of the voting preparation and implementation at implementation of a regional referendum is shown in FIG. 11.

As it is shown in the presented diagrams, the input data flows when conducting various election campaigns are processed and distributed at various levels differently.

In so doing the automation of the election processes using identical input data for combination of the processes of creation and processing of document of various election campaigns, for example, at registration of voters, at creation of voting bulletins, forms of protocols at vote count allows one to considerably reduce the operating time, the quantity of operators and the volume of the information to be transmitted.

The Subsystem of the register of voters (SVR) and referendum participants provides automation of the activity of electoral commissions of all levels associated with the registration and accounting of voters, referendum participants and with preparation and implementation of election and referenda of all levels. The SVR subsystem provides generation of data in a digital and graphic form and automated creation of a register of voters at a district electoral commission.

The block diagram of the SVR subsystem is based on the interaction of the AEC of all levels with respective external data sources and databases of the SAS system.

The external data sources of for the subsystem database are passport and visa service offices, civil registration bodies, military registration and enlistment offices, courts of justice, migratory service offices.

The Subsystem Performs the Following Functions:
keyboard input of data on voters;
data exchange with external data sources;
data exchange between the AEC and DB at all levels;
conduction of classifiers, references and dictionaries of the subsystem;
maintenance of the subsystem databases;
creation of lists of voters, referendum participants;
input of additional data on voters;
generation of reports and statistical data;
maintenance of data in subscription lists;
managing the subsystem operation;
installation and updating of the subsystem software;
data exchange with the DB of the SAS system.

The subsystem uses a system of classifiers, for example, formed on the basis of the all-Russian classifiers allowing one to identify the coordinates of the place of residence of citizens, and other important classifiers providing identification in the subsystem database of a person in the register of voters and during the voting on the basis of the document presented by him at the registration at a voting site.

In the AEC CEC the subsystem uses a DB server, a server of applications and the client software, in the AEC ECSRF use is made of the DB server and the client software. The operation of the SVR subsystem can be realized by means of any well known software, for example, on the basis of the Windows 2000 operating system.

The subsystem also supplies the users with information by means of acceptable image resources, for example, on screens of displays by means of various screen forms. A lot of images displayed on the screen can be corrected by the user according to the level of access given to him.

The subsystem provides a possibility of checking the reliability of the information identifying the voter, checking for possible doubles, checking the bibliographic data, as well as of creation and correction of the register of voters in the TVD regions, as well as a possibility of presenting statistical data on territories.

The information and reference subsystem (IRS) is intended for directory service in the work of the members of electoral commissions, managers of the electoral commission AEC CEC and AEC IKSRF by publication in the intranet network of information contained in the information fund of the whole automated SAS system. The IRS subsystem functions on the soft/hardware of the AEC AEC CEC environment and AEC IR of the subjects of the Russian Federation.

The IRS subsystem provides automation of processes of creation of information to be sent to users by their requests. This information is stored in an integrated database (IDB) of the AEC CEC managed by the database control system (DBCS), for example, Oracle 9i Enterprise, and IDB AEC ECSRF under control of the DB Oracle 9i Standard. The subsystem is run using, for example, a package of programs from the Crystal Enterprise and a client-server made in a multilevel architecture in four layers including a plurality of functional elements:
a client layer performing a task of administration of the whole subsystem, verifying the rights of users, changes of adjustment of the servers, input or removal of access keys, publication and review of reports;
a control layer performing the tasks of safety, dispatching requests to respective servers and storing versions of reports with saved data;
an operating layer forming calls directly to the database and generating reports;
a data layer linking, for example, desktop databases with relational databases or the ERP-systems.

The layer modules can be installed both on one and on several computers depending on the type of tasks to be solved. The communication between the modules can effect by means of the Crystal Business Framework, for example, using the TCP/IP protocol.

In so doing the IRS subsystem provides a common access to information resources from computer workstations (CWS) submitting the users with text, graphic and cartographic information.

The TP structure of the reference subsystem includes software providing:
automated creation of Web-pages using all information resources of the automated operational information system and their publication on the subsystem site by user requests;
common access from the user computer workstations to the information resources of the system by using standard templates for Web-pages of the second and the next levels;
automatic creation of hyperlinks for interconnected documents providing a possibility of transfer from one Web-page to another under these references;
an access from the main page of the site to the main sections of the site;
an access to the main sections of the site from the Web-pages of the second and the next levels;
photographic and thematic search;
a possibility of comparison of the election results in a graphic form by comparable data;
a possibility of output of information to a printer without the graphic elements used for navigation over a site;
user self-training using the “help” mode, which is automatically called from each Web-page and comprises a user's guide and information providing independent operation with IRS for a nonprofessional user;
a possibility of administration of the IRS by adding sections, publications of information from external sources, acquisition and processing of statistical information using the information resources of the automated operational information system according to the invention.

The IRS resources also include means for solving the analytical problems associated with complicated calculations, forecasting, and modeling of scenarios “that-if” and so on. For this purpose, the system makes use of the technology of multi-dimensional databases, for example, made in the form of a set of products of the OLAP technology—Oracle Express, which includes a server of multidimensional DB, special-purpose developments in the client-server and Web environment, as well as ready analytical applications.

The user using such a simple manipulator as a mouse can create dynamic interactive reports in a tabulated form or graphic form, obtain various fragments of multidimensional information, detail data on any hierarchical level and conduct dynamic aggregation. In so doing all obtained interactive tables, diagrams and graphics can be placed on pages which can be combined into [symbol] multipage [symbol] books or briefings. The analysis results can be easily sent by e-mail or to export on a corporate Web-site.

The interaction of the IRS with other SAS subsystems is carried out at a data level of the integrated DB.

The operation of the IRS users is performed from any computer workstation of the AEC CEC or the AEC ECSRF which are provided with a browser. The operation of the IRS administrator is performed from the administrator workstation, in which software is installed that is intended for support of the TP of the reference subsystem. The operation of the user with the IRS consists in an election of an information section using the navigation menu and filling of the search requisites. The requisites structure is determined by the user requirements. In the course of operation the user may specify a request adding or changing the search data.

The input data for the IRS are data of the IDB AEC CEC, IDB AEC ECSRF, requests for information search in the IDB.

The output data of the IRS are all kinds of references and reports formed by all the SAS subsystems.

The subsystem of display of the multiple-access information (MADI) provides a visual image of the results of election campaigns and the process of their implementation, as well as use of visualization services during the period between the election for conducting various video conferences, presentations and support of daily activity of electoral commissions, in particular, display of a current state of the AEC automated system according to the invention.

The Input Information for the Subsystem is as Follows:
external video information sources, for example, on-air broadcasting;
video, audio and graphic information prepared by means of other information systems and intended for visualization on displays;
information from the databases of the automated operational information system according to the invention.

The Output Information on the Subsystem Includes:
information displayed on displays;
hard copies of the displayed information;
archive records of the displayed information.

The Subsystem Includes Elements which are a Part of the AEC:
data sources intended for displaying, for example: personal computers, video-recorders, terminals of video conferences, video and television cameras, nonlinear image stations, television receivers;
means for information controls and distribution, for example: video-and-audio information switching devices, video processors, controllers of cartoon images, control panels, servers of a digital broadcast, radio-frequency modulators, converters;
image display devices, for example: projectors with large coated screens, plasma panels, home television receivers, screen monitors, personal computers, for example, as a part of computer workstations;
acoustic resources audio, for example, audio amplifiers and systems, microphones, mixer consoles;
resources for translation of television signals through fiber optic channels;
information exchange systems—a dedicated line of a local area network of the AEC CEC, local video networks, a cable system for transmission of video and control information.

For example, the AEC CEC include large-format displays such as a projector and a video-wall in the CEC building, small-size displays such as television receivers and plasma panels, video information distributors such as a cable television network, a system for archiving video information, audio amplifiers and systems, computers used as graphic servers which can be also used for preparation of information display.

The AEC ECSRF include video information sources such as personal computers, video recorders, terminals of video conferences, documenting resources such as color laser printers and information displays.

The soft/hardware subsystems perform the above functions at the AEC CEC, for example, the soft/hardware of the CWS includes well known operating systems. In so doing the computer data processing workstations of the CWS have a standard video system of a class not lower than XGA and can provide operation of the “Cartography” package of programs of the subsystem of automated election processes, graphic packages of two- and the three-dimensional pictures, animation packages, database reporting facilities. The control and commutation facilities provide a possibility of local individual monitoring with creation of information images displayed from the operator workstation. The images transmitted of images from the control devices to large-size displays such as plasma displays are sent as RGB signals.

When monitoring the course of election or referenda and summation of the voting results, the information to be displayed is formed mainly by means of the [symbol] Cartography [symbol] TP and using graphics packages and other software for creation of any graphic and text information.

The television and video conferences are organized using an information source in the form of a video signal from television and video cameras and video terminals.

When conducting conferences and presentations the main data sources are a video recorder and personal computers.

The capabilities of the image display subsystem allow simultaneous display in a multi-channel mode, for example, of up to 15 sources of video information.

The operation control and monitoring subsystem (OCM) provides automation of control processes, status data acquisition and processing and operation of the SAS subsystems and elements including computers, network equipment, operating systems, databases and AEC of every level, regional fragments of the SAS, centralized control and monitoring of the SAS as a whole at the AEC CEC level. The subsystem provides independent operation of each component incorporated in this system.

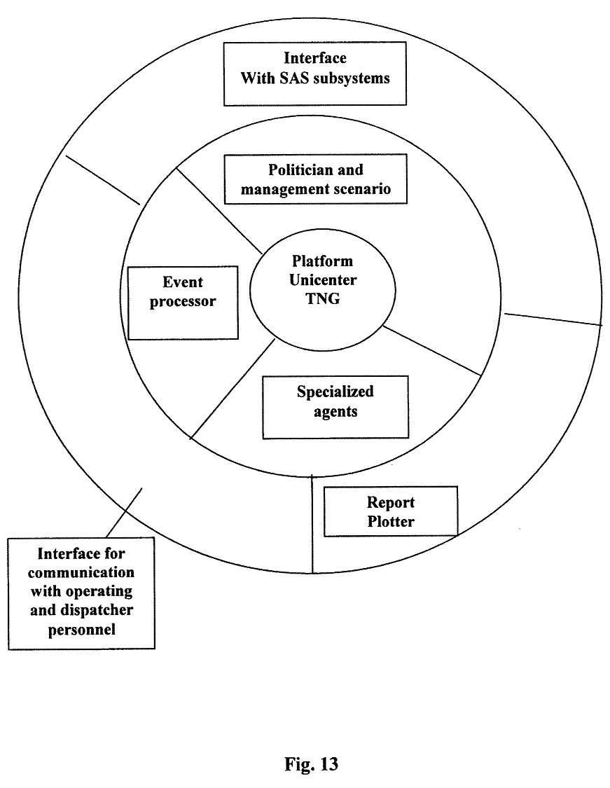

For example, the structure of the OCM subsystem is based on the well known universal platform CA Unicenter TNG. In this case, the subsystem core realizes the “manager-agent” scheme (FIG. 13). This scheme provides control, event processing and special functional tasks, and the information is submitted to the users and dispatching operators by means of interfaces and plotters of reports.

The arrangement of components of the OCM subsystem is shown in FIG. 14. The interaction of the subsystem elements is performed by means of a data transfer subsystem.

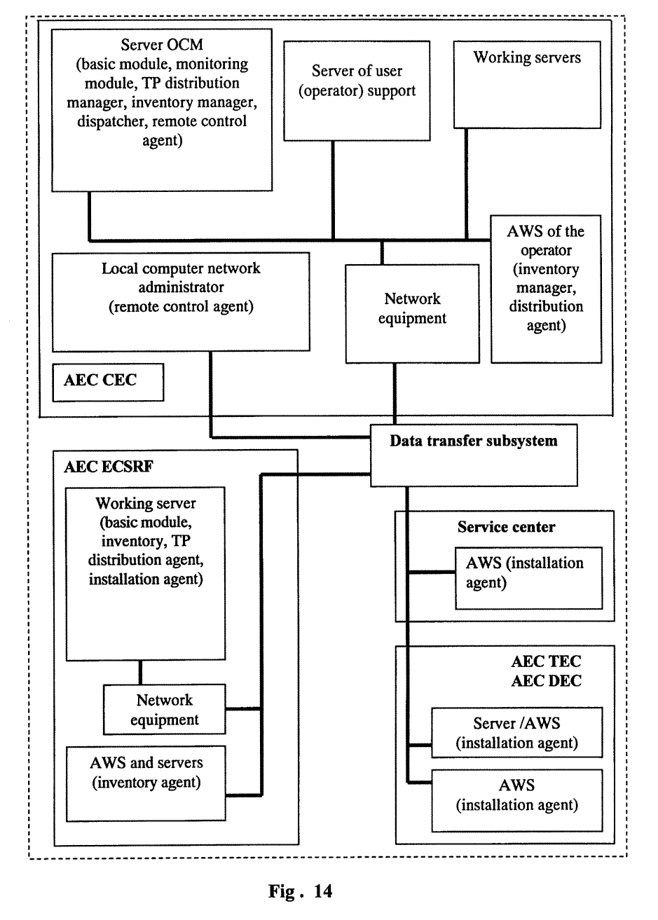

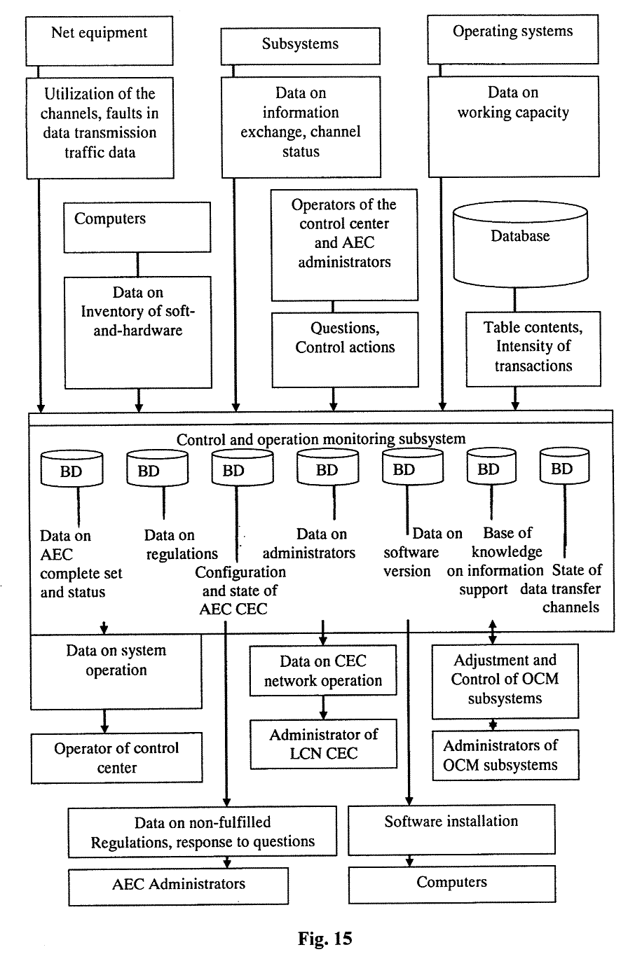

A flow diagram of input and output data of the OCM subsystem is shown in FIG. 15. Each agent gathers data and controls a certain element of a network or an application. The managing servers of the control system obtain data from the agents, generalize them and store in the DB. Each control object sends its own data set, which the OCM subsystem receives, processes and stores, and then according to the selected control policy produces a control action and transfers it to a desirable control object.

The interaction of the OCM subsystem with the other SAS subsystems is carried out through an integrated DB. A set of DB of the OCM subsystem operating on the basis of the DB resources are subcircuits of an integrated DB. In this case, the DB determines access rights to the DB subcircuits. The DB OCM subsystems present a data set necessary for support of the interaction of OCM subsystem with the other SAS subsystems.

For example, to obtain data for monitoring the regulation, the OCM subsystem uses the information gathered by the subsystem of automated election processes. Each operation is characterized by a type, a place and time of its implementation. Each regulation of an election campaign represent is a list of works to be carried out is linked with a concrete election campaign. The date and result form a work status. The set of work statuses allows one to track the course of performance of regulations and its violation. The subsystem of automated election processes monitors the processes of information exchange within the limits of the election campaign and transfers the information on the end of works to the OCM subsystem.

The information support means of the users of SAS of the OCM subsystem include electronic “bulletin boards” and means for support of [symbol] hot lines [symbol] , for example, in a question/answer mode.

The OCM subsystem provides automatic operation in two operational areas—the area of control of the operation of the soft/hardware devices and the area of acquisition and processing of the information on the state and operation of all subsystems of the automated operational information system according to hierarchical principles of its construction:
remote inventory of the AEC soft/hardware;
remote distribution and modification of the special software;
remote monitoring and search of faults in the AEC;
acquisition, processing and submission of data on failures in the regulations for presenting guideline information;
creation of information funds relating to service and control of the system operation.

The OCM subsystem provides, for example, automated control of a local area network AEC CEC (LAN CEC), checking the completeness and state of the SAS, monitoring the data transmission channels.

FIG. 16 is a diagram of an automated test of a technical state of a local area network AEC CEC.

For user convenience, the state of realization of the monitoring functions may be presented by the OCM subsystem in the form of a map, on which servers, CWS, network devices and data channels and their characteristics are shown.

In the OCM subsystem built up in an architecture of a control system with distributed “manager-agent” information systems, two sets of control standards are used—on the basis of the SNVP protocol and the ISO international standards using the CMIP protocol as a protocol of interaction of agents and managers.

The data on current loads on the data channels from network devices are fed to the OCM subsystem, and are dynamically analyzed and used for preventing an overload of the data channels, for example, during federal election, by using the backup possibilities of the subsystem.

At the moment of peak loads on the central servers AEC CEC, for example, on the day of voting during the federal election, on the safety subsystem using the information on the active mode of the databases co-acts with the OCM subsystem for rising the capacity of the servers and can transfer the DB servers in a mode of limited access to the users informing the OCM subsystem about this action.

The use of the subsystem allows one to reduce the operating cost at the expense of minimization of idle times and qualitative adjustment of the equipment, to operatively solve arising problems due to constant control monitoring the equipment for possible faults, to create a flexible scaled information infrastructure due to its quick reconfiguration, evolution and extension, as well as to provide installation, adjustment and support the AEC system elements with necessary software.

The information security subsystem (ISSS) providing authentication and delimitation of the authority of the users, monitoring attacks from external sources, cryptographic protection of information flows, and virus protection. This implies conduction of policy of safety by creation, removal and modification of service and security mechanisms, distribution of respective information and reaction to incidents, support of common access to the SAS system, monitoring the service of directories.

The personnel training subsystem (TS) is a combination of resources and methods of education and organizational structures to carrying out an educational process. The personnel include experts of the SAS, for example, employers of the CEC apparatus, system administrators of AEC at all levels and the AEC service personnel, and the SAS users, for example, members of electoral commissions and their secretariat, employers of other federal, regional or local structures who have the right to use the SAS resources. The package of programs for organization of training and programs for remote training are applied using the Web technology.

The structure of the TS subsystem has three levels: with coordination by hierarchy and a support of educational processes.

The Ts Subsystem Comprises the Following Elements:
information service including structured information arrays, for example, an information fund and classifiers, incorporated into a local database of the TS subsystem;
educational and training bodies including plans and programs, learning courses and training techniques, qualification requirements to the SAS specialists and users;
organizational measures including, for example, organizations, divisions and individual permanent staff carrying out the learning process;
software including programs for automatic solution of problems of the TS subsystem;
hardware for operation of the TS subsystem.

The information exchange between the levels of the TS subsystem is carried out through fragments of the local database of the OK subsystem by data replication, e-mail, via telecommunication channels using the TCP/IP protocols and by a file transfer on carriers, for example, CD-ROM.

The TS subsystem is distributed and standalone. If necessary, the information exchange with other subsystems is carried out using standard resources of data import and export.

The maintenance and service subsystem (MSS) at all levels provides software testing and back-up, creation of models of reconfiguration of regional fragments of the automated system for simultaneous implementation of several election campaigns, software installation, modernization of the automation equipment of the automated system according to the invention and for solving other tasks. The subsystem closely cooperates with other subsystems, for example, with the subsystem for automation of management activity and with process control and monitoring subsystem.

In addition to the MSS, an important participant of service is service centers whose main function is service of the soft/hardware means CAS SAS. In this case, each service center can be connected to several CAS of various levels. Each center has a stand used for modeling the SAS operation.

The subsystem database is a part of the distributed SAS database and is placed on the servers of CAS CEC, CAS ECSRF and on the stands of the service centers.

The subsystem database is a part of the distributed SAS database and is placed on the servers of CAS CEC, CAS ECSRF and on the stands of the service centers.

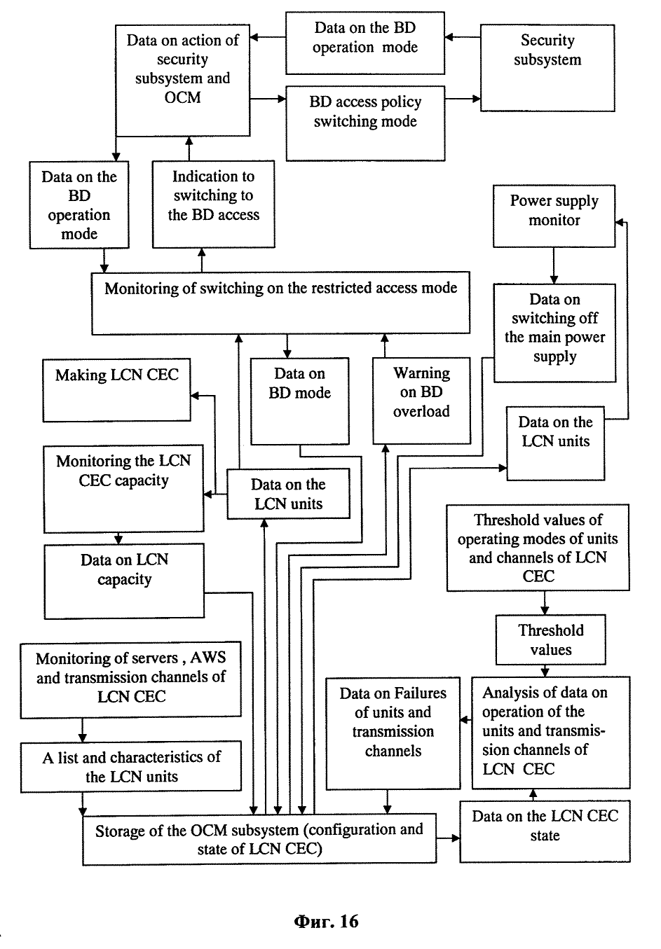

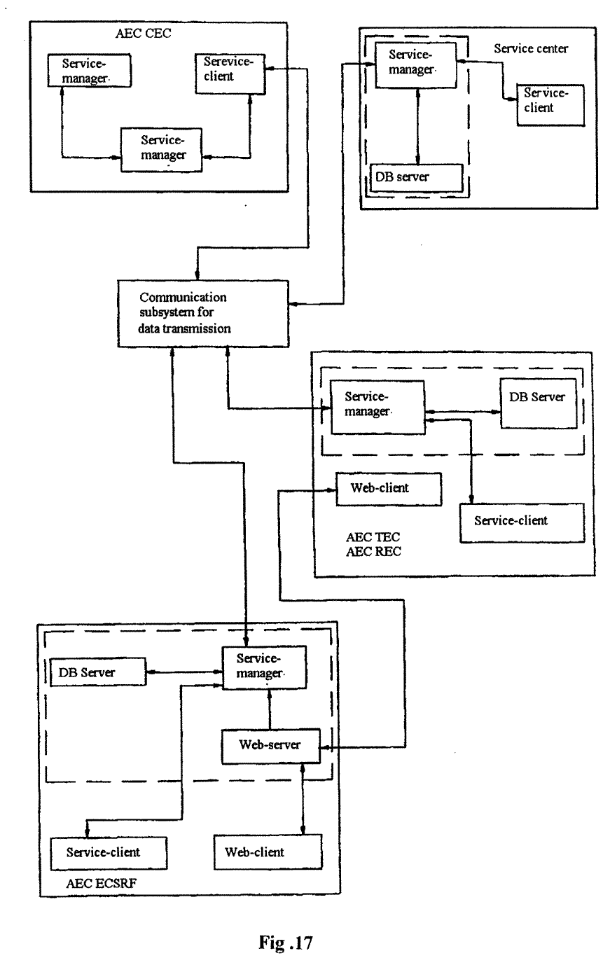

The subsystem provides a possibility of printing service documents of all objects and levels by means of any known software, for example, by means of the Word text editor and Excel electronic table. The subsystem is run by the “Service” package of programs developed on the operated objects: the CAS CEC (three-level model with a dedicated server of applications), CAS ECSRF (three-level model without a dedicated server of applications) and the soft/hardware stands of the service centers. The “Service” TP architecture is shown in FIG. 17.

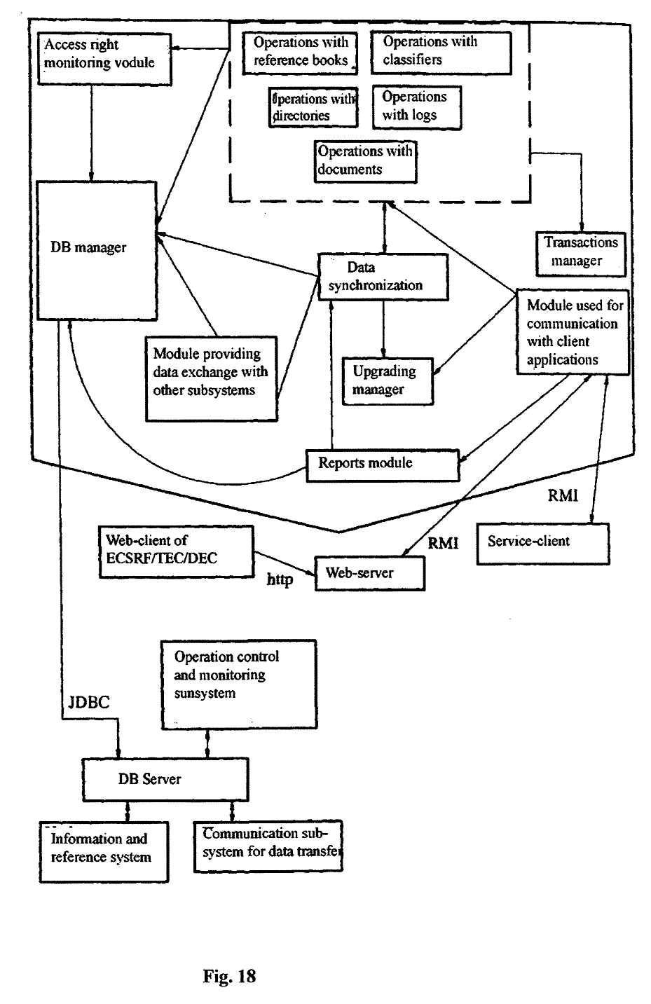

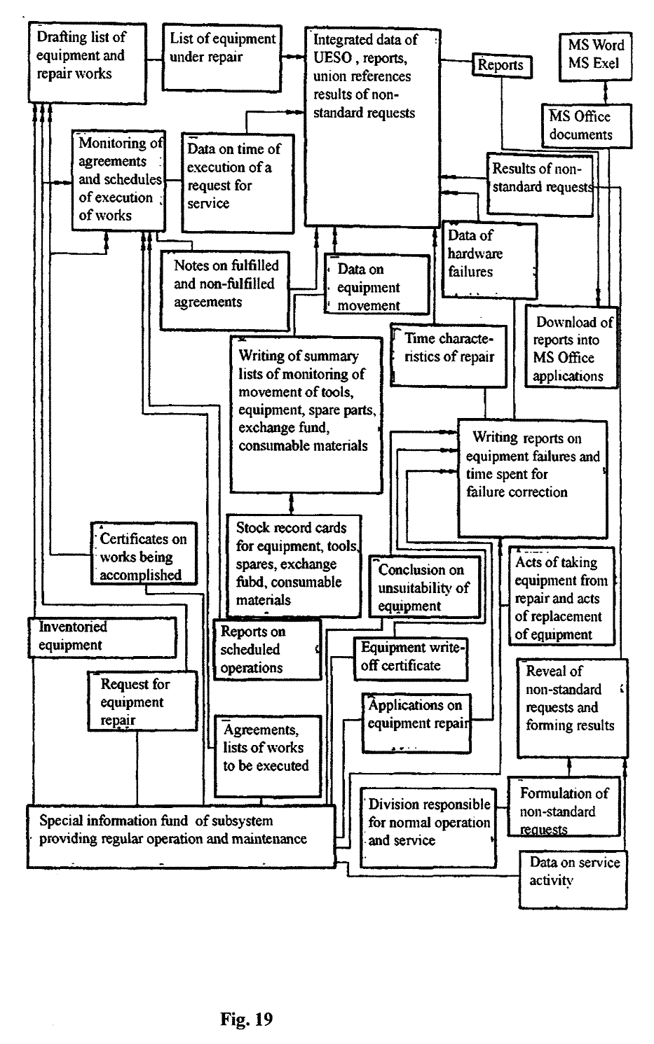

In so doing it is expedient to use a three-link technology, for example, with three-level architecture:
data storage, in the DB server, for example, for the CAS CEC—Oracle 9i Enterprise Edition with a server of applications Oracle 9i, for the TP unit as a part of the soft/hardware package of the service center (with server DB Oracle 9i Standard Edition), for the CAS of territorial and district electoral commission—in the form of a three-level model without a dedicated server of applications, where the DB SQL base is used as a DB server;
logical realized by the “service-manager” program (FIG. 18);
presentation realized by the “services-client” program.

In this case, in the DB three-level architecture the data storage level does not include functional tasks responsible for the logical level. The DB keeps the history of change of the objects of storage and creation of data for response to requests. In this case, the following objects are used:
classifiers, for example, in the form of linear value lists, for example, of repair types;
references, for example, in the form of objects with a complex structure providing identification by name or by object code, for example, of a hierarchical construction. The reference element is characterized by a code, value and a set of properties. For example, “CAS objects”, [symbol] system administrators”, “electoral commission”, “developers”, [symbol] repair centers [symbol] “suppliers”, [symbol] service centers [symbol] ;
documents, for example, [symbol] delivery plan [symbol] , “working plan”, “act”, etc.;
catalogs, for example, [symbol] registration elements [symbol] , “equipment”, “printers”, “monitors”, etc.;
events of a subject domain having exact date and place of occurrence, for example, “inventory”, “repair” and so on;
logging the events of one type in strictly chronological sequence and hierarchy, for example, <<the facts of movement of the equipment>> and other events.

The subsystem provides, for example, an automated process of inventory calculation, in particular, by means of soft/hardware devices.

Data exchange between the CAS servers can be provided by means of the data transfer medium used in the SAS.

The information security is provided by protection of that CAS, in whose environment the TP “Service” functions.

Supervision of the access to the resources of the computer workstations with client applications is provided by respective protection systems in a scope of functionality determined by proper adjustment including creation of a closed software environment.

The information representing the result of operation of the TP of the whole subsystems of the state automated system is published on a Web-site according to an approved output form.

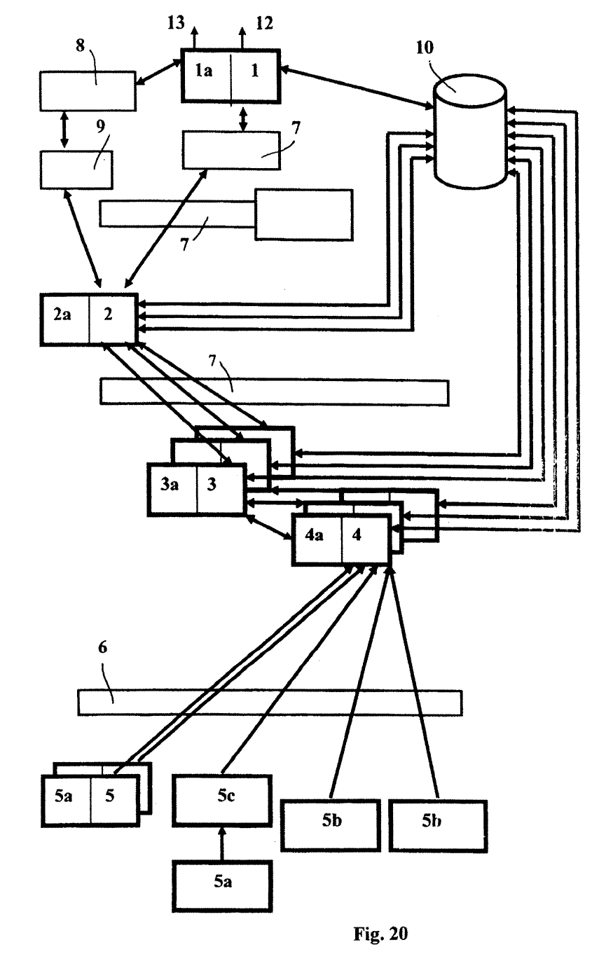

The realization of the method of voting preparation and implementation by means of the claimed system, and the interaction of the elements of the automated operational information system according to the invention during the operation of the above described subsystems may be illustrated on an example of interaction of the CAS of various levels of the SAS at the presidential election in the Russian Federation as shown in FIG. 20.

The central element 1 of the system according to the invention is located at the first top level of the system in the element 1a of the voting networks—the central Electoral Commission of the Russian Federation; elements 2 of the second level of the system are arranged in elements 2a of the voting networks—electoral commission of subjects of the Russian Federation, elements 3 of the third level are arranged in elements 3a of the voting networks—in the district electoral commissions, elements 4 of the fourth level—in elements 4a of the voting networks—in the territorial electoral commissions, elements 5 of the fifth levels—in elements 5a of the voting networks—the local electoral commissions.

The elements 1-5 of the systems are interconnected through a transmission environment based on the radial-central principle with a central unit in the central element 1 and units in the elements 2 which, in turn, are connected by communication lines to elements 3 and 4, and include suitable communication facilities, for example, communication channels 6 of a public telephone network, digital communication channels 7, satellite communications channels 8 and 9.

Shown in the drawing is element 5c of the systems whose location does not coincide with the location of elements 5a of the voting networks, and transmission of information between element 5c and element 5a of the voting networks is carried out by means of acceptable communication facilities, and elements 5c are mobile and adapted for implementation of correspondence voting with the help soft/hardware means. There are also shown elements 5b of the systems which are also elements of the voting network—mobile resources of electronic voting.

The element 1 of the operational information system is the control element. The elements 1-4 with other elements of the voting network are connected via communication facilities to a database whose creation and operation is carried out by means of a server 10 connected to the elements 6-9 of the systems and provided with an operating system, for example, the DB of the Oracle system.

Such a modular structure of the automated system allows one to search the necessary information, and automatically perform a preset scenario of operations of the system.

When starting the election campaign on presidential election, the central element 1 forms a structure of a territorially distributed voting network, providing allocation of the elements 2-5 in the voting region taking into account its division into administrative-territorial sites, and to support the elements with communication facilities and necessary technical facilities.

The central control element 1 forms a structure of an operational information system comprising a necessary amount of elements-modules, at least one of which is a central control element 1 arranged at the central control station of the voting network, and another element, for example 12 is connected to other external bases (not shown in the drawing), and an element 13 is adapted for output of information intended for open acquaintance from the operational information system.

Then the general-purpose and dedicated soft/hardware are installed in the elements of the operational information system and tested under actual operating conditions.

In the course of operation of the automated system the soft/hardware facilities are continuously monitored and the software package is updated. In the process of installation of a service pack, a preset scenario of actions is carried out automatically. This scenario may include operations which a file system, a start of a script for database modification, a start of an executable module, a stop/start of the Windows services, and computer reboot. Then a procedure inventory is started, in which the presence of all information, operational and servicing systems of the element of the operational information system is checked, as well as correspondence of the files to a preset standard. The results of the inventory procedure are put in a report.

After that the elements 1à-4a, 5a, 5b and 5c of the voting network are connected to the elements of 1-5 of the system with a server 10.

Selection of operating personnel of electoral commissions and their training is effected.

After forming the elements of the automated system, all organizational and accounting activity of the elements of the voting network is carried out according to the obtained references and reference documents, and formalized criteria for estimation of the activity of voters, formalized indices, reporting and accounting forms are established.

A common database of the election campaign is generated. In so doing the use of the modern multi-user DB Oracle provides complete integration of the functional systems of the automated system with creation of integrated databases at each level of the system elements with a complete combination of logical data structures over the whole system according to definite rules.

Using the element 13, information blocks are formed comprising the necessary legal, reference and normative information, forms of reports and registration for operation of the voting network sites, as well as information for conducting agitation work, terms of communication session and instruction for calling the database, installed classification codes and identification indexes of various information objects. For example, the indexes identifying an electoral commission, a voting place, a type of request, user's address, a voter's sex, age, etc. And send these data to the server 10 for when creating a common database of the election campaign and dispatch to the territorial voting sites.

Besides, lists of prospective voters available in the database are presented, which are set up according to the place of residence of the voter at a [lace of allocation, for example, a site, district, territory, a Federation subject, voting region.

The team of the electoral commissions of the elements 1a to 5a of the voting networks performs preparatory, organizational and agitation work and generate primary information on promotion of candidates, checks the data on the candidates, for example, by a request in external databases through the element 13, for example, to the state automated systems “passport control”, “frontier control”, “migration”, “justice”, <<population state register>>.

The information prepared at each point of the voting network is sent to an element of the automated system, for example, to the element 3 which enters this information into the database and processes the information objects to create data blocks comprising an information object, an index identifying this object, an index of a point of the voting network, an index of the element 3 and the time of input of the information. The blocks are stored in the database, and are made available to a user by his request, for example, via the element 4, for review provided that is authorized for access within the scope according to the element 3.

In this case, the operation of points of the voting network is strictly regulated by time and volume of information prepared for reports that makes possible an operative input of the information into the soft/hardware facilities, quick search and its quick statistical processing, as well as data transfer to other elements of the system.

The central electoral commission gives established forms of voting bulletins and puts them into the database. After registration of candidates the commission forms a voting bulletin, containing not less than two registered candidates and two selection fields for each candidate, said bulletin being printed on a paper carrier.

During the voting procedure at points of the voting network the voters are registered on the basis of the established voter identification parameters, for example, a date of birth, a birthplace, surname, name, patronymics.

The voters take bulletins or other voting documents and the secretary registers the fact of their output putting down an electoral commission mark thereon.

Bulletins are accepted from the voter in means of reception of bulletins, for example such as a closed voting urn. After the voting time is over, the urn is unsealed, and the members of the electoral commission count the accepted bulletins, check them by criteria of validity and the presence of marks of the voter election. The accounting forms are filled and a total protocol is written.

When using electronic voting resources, the voters are given an image of a voting bulletin, the voter's selection is registered, an automated statistical processing of voting results is made, and protocols of the voting results are formed in an automated mode.

The protocols are directed to electoral commission of a higher level of hierarchy, for example, from a local commission in a territorial one, and then, after creation of a protocol by the territorial commission it is sent to the district commissions, in parallel sending the information in an established format is sent to an element of the system for information input and processing.

The central electoral commission sums up the voting results and makes a decision on termination of the election campaign or its repetition, and gives to the elected person the document on his/her election.

During the operation of the system it is automatically protected against unauthorized access by means of programmed processes of information coding, checking the content of the entered information, user identification, call check in the system, and blocking any attempt of penetration into the system.

During the voting preparation and implementation an automatic access to information resources of the automated system is provided via the Web network, open access for acquaintance in the on-line mode on accessible displays and visualization means, for example, on a display screen, on a large-size screen, as well as by publication in mass media, in the Internet network, when conducting video conferences.

The method of voting preparation and implementation using the automated systems according to the invention can be used in election campaigns of a various level, in various voting regions having different territorial extent and a different amount of voters in the voting regions. For example, the method can be used both for presidential elections and for elections of officials for various regional communities.

In so doing the method of preparation and implementation of elections according to the invention allows one to combine preparation and implementation of campaigns of federal, regional and local levels, for example, at a municipal level and provides joint work of several electoral commissions with using the same complex of elements of the automated system, common systems for communication and imaging the information for a user.

Besides, the method according to the invention allows one to apply new resources of automation and/or to modify their equipment while keeping the common system approach to the operation of all elements of automated system using a single set of soft-and-hardware a common enhanced interface. All functional components of the automated system can be based on an integrated database structure of the automated system modeling a subject area of an automation object, and also based on a basis of a common classification and coding the information objects. Such a design of the system allows one to considerably reduce the information search time and to provide quick data processing for reception of statistical data and to carry out forecasting and the analytical analysis of the results in real time. Thus automated system includes standard software packages allowing one to solve the tasks of organizing the work of electoral commissions in an automatic mode and to provide information with screen imaging with a possibility of its printing.

Thus the automated system can be generated anew or with usage a structural network of units of the system available on the territory and having the described above possibilities, or its part using the available communication networks and preserving the interaction of necessary peripheral elements of the system with a central element and a system database.

Informational resources of various level can be used, for example, legal information concerning the common rules of the law, the election registers, which according to the invention are supported by system in an actual state.

Besides, the system according to the invention can also be used for preparation and implementation of several election campaigns and referenda in one voting region, with voting in the same day, and in different regions of different campaigns simultaneously, with voting at different time.

Thus in the automated system according to the invention, having the territorially-distributed structure of elements, the disposition of system elements can coincide with places of allocation of the voting network or be arranged in another way.

Therefore, application of the method of voting preparation and implementation according to the invention with help of an automated system allows one to make the election transparent to automate routine procedures of drafting the accounting forms to exclude false bulletins and to provide election process monitoring.

### INDUSTRIAL APPLICABILITY

The method of voting preparation and implementation according to the invention and the automated system for effecting this method can be realized by means of well known high-tech computer technologies using well known soft and hardware.

1. A method of voting preparation and implementation by means of an automated system comprising the following working steps:
forming a territorially distributed voting network containing at least the following elements of said network:
territorial sites allocated in the voting regions and providing at least:
presentation for open acquaintance of the information on the forthcoming election;
registration of voters;
submitting to the voter a bulletin containing at least two selection variants and made on a suitable carrier with a possibility of making a mark in the selection field;
calculation of the amount of the issued bulletins;
reception of the bulletin filled by the voter;
calculation of the amount of the accepted bulletins;
calculation of the amount of the marks made with respect to a selection variant;
generation of the return data containing information objects in a preset format; and
a central control station, said elements being interconnected by means of suitable communication facilities, said sites being adapted at least for capture, reception, counting, registration, processing, saving and delivery of information in a preset format;
development of automated operational information system for voting preparation and implementation including a network of territorially distributed elements of the automated system including complexes of soft/hardware means interconnected by suitable communication facilities and allowing one to perform the following operations in a mode of an authorized access in real time and/or in session time:
reception of information containing information objects prepared by the voting network elements in a preset format, and input of information input in the element of the automated system;
processing of said information with a possibility of imaging the information objects as a text and/or graphics and/or in a digital and/or tabulated form with a possibility of editing said image;
previewing the displayed information objects, check their correspondence with the information prepared by the voting network element;
entering additional data in the objects of said information, allowing one to identify said objects as objects relating to the voting and presented by said voting network element in a certain instant of time and to identify the element of the automated system providing input of said information objects into in said automated system;
subsequent record and accumulation of said information objects with a possibility of data processing by the cumulative sum;
transmission of said information objects to other system elements;
display and visualization of the information objects;
saving said information objects;
identification of the user of the automated system at his call to the automated system element;
And thus the system contains peripheral and central elements and:
at least one of the central elements is a central control element of said system and is also adapted for monitoring the operation of the other elements of the automated system and the automated system contains:
at least one system element adapted for connection with other external databases and made with a possibility of reception of a request from a system element, containing at least data on the information object requiring an explanation and/or additional information from the other databases, and an identifying index of a system element, creation of a request, its direction to the other databases, receptions of the answer and a direction of the answer to the system element which have sent request;
at least one system element connected to one central element and to the database server of the system and used for:
giving to the users an access to the information resources of the automated system on the Web-technology basis;
on-line open access to the information on the course of voting and on the preliminary voting results being automatically processed in a real-time mode in the voting region by means of a suitable interface and displays at sites of the voting network and in the voting region as a whole;
publication in the Internet network of the information on the course of voting and the total voting results within 24 hours after the voting is over;
displaying the data on the course of voting and the final voting on large-size displays;
installing in the complexes of soft/hardware means said general-purpose and dedicated soft/hardware devices allowing one to carry out on-line in an automatic mode monitoring of their state by testing, remote distribution, inventory and upgrade of the dedicated soft/hardware means providing reception, processing and transmission of data in the course of performance of regulated data exchange between elements of the system and with an environment, as well as adjustment of the elements of the system for solving the functional tasks of different complexity;
providing the equipment of the voting network elements and the elements of the automated system with qualified personnel, and carrying out their training;
providing the information transfer from the voting network elements to the automated system elements;
forming a common database of the automated system while carrying out:
reception, record, accumulation and saving of the information objects incoming in real time and/or in session time from the automated system elements;
processing the received information objects with creation of address blocks including information objects relating to one type of voting and/or one element of automated system and/or to one of the voting network element and/or one direction of activity of the system elements and/or one user, and savings of the address blocks with a possibility of their recovery;
processing the information on the address blocks with creation of final data blocks containing information with cumulative total and saving the final data blocks with a possibility of their recovery;
processing the information contained in said data blocks, address blocks and final data blocks with creation of statistical data blocks by the parameters prescribed by normative legal acts and their saving with a possibility of their recovery;
input in each of said information objects, address blocks, final data blocks, statistical data blocks an additional classification index allowing one to identify each of said objects and/or blocks in the database;
generation of data blocks containing information stored in the common database according to the dispatch regulations provided for the users registered in the database;
generation of open data blocks according to the prescribed list of information for the future open representation by means of visualization tools;
generation of open data blocks according to the prescribed list of information for the future open representation on sites of Internet;
saving the copies of the initial and corrected data blocks of the common database on a carrier acceptable for operation in the automated system not connected to a database;
registration of the issue and movement of strict accountancy documents including voting bulletins;
saving the general-purpose software packs installed in the elements of the automated system and the results of testing the state of the soft/hardware elements of the automated system during monitoring;
saving the dedicated software packs installed in the elements of the automated system including initial packs and service packs,
and providing operation of said automated system in an interactive mode for directory service of users of a common database and support of operation of elements of automated system and elements of a voting network and, thus in an automatic mode provide:
support of the information stored in the common database in an actual state by means of correction and updating;
reception of a user call in the common database and its saving;
checking the presence an identification index in the call, determining the scope of the user's access rights, establishing the scope of access to the information in the common database,
search of information in the common database, according to the call and the scope of rights given to the user,
generation of a response block to response to the user call,
providing the user with a generated response block in the browse mode according to scope of rights given to the user if the user call to the database contains an identification index corresponding to the identification index of this user stored in said common database;
forming a voting bulletin containing at least information allowing one to identify the accessory of the bulletin to the voting bulletins including at least two selection variants from the amount of the registered selection variants and having at least two localized selection fields adapted for making a selection by introducing by the voter marking element in one of the selection field;
making a voting bulletin on a carrier acceptable for voting;
registration of voters;
giving the voting bulletin to and taking it from the voter;
counting the accepted bulletins and checking them for correspondence to the established requirements of recognizing the bulletin as valid;
counting the votes concerning each selection variant;
generating data on the course of voting and its results;
forming summary data on the voting by performing the following steps:
providing a possibility of data exchange between the voting network elements and the automated system elements;
performing automatic protection of the automated system against unauthorized access;
providing information security;
giving to the users an access to the information resources of the automated system on the Web-technology basis;
on-line open access to the information in the course of voting and on the preliminary voting results being automatically processed in a real-time mode in the voting region by means of a suitable interface and displays at sites of the voting network and in the voting region as a whole;
publication in the Internet network of the information in the course of voting and the total voting results within 24 hours after the voting is over;
displaying the data in the course of voting and the final voting on large-size displays

2. The method as claimed in claim 1, characterized in that when creating said territorially distributed automated operational information system, the allocation of the peripheral elements of said system is carried out in voting region.

3. The method as claimed in claim 1, characterized in that the users of the common database are given information generated in blocks:
information on the beginning of the election campaign;
data including regulatory legal acts regulating the activity on the voting preparation and implementation and necessary legal information;
data containing time schedules of work on voting preparation and implementation and on the final voting results;
data containing information on administrative territorial division of the voting region;
data on the operation of the central control station and territorial voting network sites during the voting preparation and implementation;
data including documentary forms prescribed for reports in various organizational structures connected with the voting with a possibility of filling these forms,
data including preliminary, current and total reports on the voting preparation and implementation;
data generated in the course of the voting preparation and implementation by each automated system element,
data on the voting preparation and implementation at a definite site of the voting network,
data on the object to be included in the number of selection variants for voting;
data including a list of registered selection variants for voting,
data on prospective voters;
data including lists of prospective voters according to the administrative territorial division of the voting region;
data including a form of the voting bulletin and requirement to its content;
data on the formed voting bulletin with a possibility of its duplication on a carrier acceptable for voting;
data on registration of the voter and on the voting bulletin submitted to him;
data including lists of registered voters including results of checking said lists for the presence of “doubles”,
data on the voting process dynamics and on the quantity of cast votes during the voting time;
data containing information on the beginning, end and content of the agitation campaign in a voting region;
data containing information on the voting summary in the voting region and/or its administrative-territorial voting sites;
data containing information on the documents granted to the elected person,
data of the statistical processing of the obtained information supplied from the system elements and from the voting network elements in the process of voting preparation and implementation;
information on closing the voting;
data containing information on arrival, expenditure and return of monetary funds intended for voting preparation and implementation;
information on termination of the election campaign;
information on termination of the powers of an official and/or authority;
information on granting the powers to the elected official and/or authority;
information submitted in accordance with a prescribed list of information given for the future open access to mass media and/or acceptable visualization tools;
information submitted in accordance with a prescribed list of information submitted for future display on sites of the Internet network;
information on the operation of the soft/hardware elements of the automated system and communication facilities and on the results of monitoring their status and service with a possibility of displaying the information contained in said blocks on a display.

4. The method as claimed in claim 1, characterized in that the data containing information on the regulatory legal acts on the voting preparation and implementation at least includes:
voting type and purpose;
voting region and its division into administrative-territorial sites for voting preparation and implementation;
date and time of the beginning and end of the voting preparation procedure;
date and time of the beginning and end of the voting;
criteria on estimation of the selection variant for its registration as a variant given for voting in the voting region and/or its voting sites;
voting resources rendered to the voter for realization of his/her selection rights;
voter identification parameters;
criteria for recognizing the voter as registered for voting purposes;
criteria for recognizing the bulletin filled by the voter as valid and for the selection being made;
criteria for recognizing report of the site of the voting network on the voting results as valid;
criteria for recognizing the voting as implemented;
indexes assigned to said type of data for their identification in the common database information content.

5. The method as claimed in claim 1, characterized in that the data containing information on the administrative territorial division of the voting region contain a graphical image of a map of the voting region with indication of boundaries of the division of the region into sites with a possibility of detailing the parameters of the voting site.

6. The method as claimed in claim 1, characterized in that data on operation of the central control station and territorial sites of a network of the voting, carrying out the activity on the voting preparation and implementation contain at least:
regulatory legal acts regulating their action;
functional features of said sites, their interaction, and a hierarchic structure of the voting network;
prescribed forms of accounts and reports;
information on the personnel;
scope of rights given for realization of the personnel activity;
information on special identification indexes assigned to each of the elements of the system, which must be included in the volume of the information block generated by said elements for input into said common database and/or for transfer to other elements and/or automated system, and allowing said automated system to identify the data source, and the information by accessory;
data generated in the course of the voting preparation and forming voting documents including accounting documents;
information generated by the element of the automated system in said data blocks containing information received by the system in the course of the voting preparation and implementation, and providing a possibility of its display in the form of a text and/or graphics and/or digits and/or a table;
date and time of the beginning and end of the activity of said voting network cites.

7. The method as claimed in claim 1, characterized in that the data on the object to be included in the number of selection variants presented for voting contain at least:
parameters allowing one to identify an object of a supposed selection among the other supposed selection objects;
data necessary for conduction by the voter of comparative estimation of the selection variants;
data registered according to the requirements of the regulatory legal acts for selection variants submitted for voting, in the scope of data necessary for conduction of comparative estimation of the selection variants;
information on the selection variants which have been given up in registration, and on the reasons of such a refusal.

8. The method as claimed in claim 1, characterized in that the data on the prospective voter contain at least:
data on the person who has reached the age of legal capacity for voting residing within the administrative-territorial site of the voting region allowing the system to identify him among the other persons living in this area,
data on the voting process participant necessary and sufficient for his identification among prospective voters,
a list of prospective voters reached the age of legal capacity for voting and living in one of the administrative-territorial sites of the voting region,
data on the person who has reached the age of legal capacity for voting who expressed a desire to vote at a voting site which is not his residence place,
data of the documents given to the voter by his request for voting at a voting site which is not his residence place.

9. The method as claimed in claim 1, characterized in that the voting purpose is selected from the group including a referendum, presidential election, election of a higher official, election of a head of a municipal union, election of a head of administration, election of a deputy, a recall of a person from an elective post, a recall of a deputy.

10. The method as claimed in claim 1, characterized in that the voting type is selected from the group including direct voting and correspondence voting.

11. The method as claimed in claim 1, characterized in that the voting region is selected from the group including a state, a federal division, a subject of the Federation, a municipal union, an administrative-territorial site.

12. The method as claimed in claim 1, characterized in that in one voting region the voting preparation and implementation is effected for pursuing several objectives of voting at any combination of the voting purposes and types.

13. The method as claimed in claim 1, characterized in that the voting is effected for a referendum, a recall of a person from an elective post, a recall of a deputy, the selection variant being an answer to at least one question, the bulletin has at least two selection fields for an answer to one question, and the answer is fixed in the bulletin by making a mark in one of the two selection fields.

14. The method as claimed in claim 1, characterized in that voting preparation and implementation is effected for the purpose of selection from the group including presidential election, election of a higher official, election of a head of a municipal union, election of a head of administration, election of a deputy, the common database of the automated system comprising:
data on registration of an election campaign with assignment to it a special coded index which must be included in the data blocks concerning the voting preparation and implementation for the selected purpose, and allowing one to identify such information in the common database information content;
information on the beginning of the election campaign;
information on the beginning and end, and on the content of the agitation campaign;
information on the termination of the election campaign;
information on the termination of the powers of the official and/or authority;
information on granting the powers to the elected official and/or authority;
data on the election collectives including political parties and/or election blocks and/or initiative groups of voters slating a candidate including:
information on the involvement of said election collectives in election campaigns;
information on the authorized representatives of the election collectives;
data on the candidate slated by the election collective including data on his property and income;
data on the authorized representatives of the candidate;
data on the documents given to the registered authorized representative;
data on the arrival and expenditure of the money resources of the election funds of the candidates and on the obtained budgetary funds including for free broadcast time and printing areas;
data on registration of a candidate to be included in the voting list as a voting object;
data on the documents granted to the elected person;
and additionally:
the results of monitoring the legitimacy of the donations;
data on the expenditure and return of the money resources of the election funds of the candidates and on the obtained budgetary funds including for free broadcast time and printing areas;
the results of checking the data on the candidate property and income;
forming and handing to the candidate the documents of his registration;
forming and handing to the candidate representative the documents of his election

15. The method as claimed in claim 1, characterized in that the automated system elements are arranged at places of allocation of the voting network elements.

16. The method as claimed in claim 1, characterized in that the voting network has a multilevel structure according to the established administrative territorial division of the voting region and the hierarchy of the voting network elements.

17. The method as claimed in claim 1, characterized in that the parameters of voter identification are a surname, a name, a patronymic, a date of birth, a birthplace, a residence or registrations and an identity card.

18. The method as claimed in claim 1, characterized in that to the information submitted to the user for review is in the form of data blocks to be displayed on a display and selected from the group including:
a data block containing an index identifying this user;
a data block containing information permitted for access to the user authorized for this access;
a data block for open acquaintance.

19. The method as claimed in claim 1, characterized in that the user is provided with statistical information in the course of voting preparation and implementation on an appropriate cartographic map of the territory and/or sites of the administrative territorial division of the voting region and/or voting region as a whole in real-time mode and/or in a session time.

20. An automated system for realization of the method of preparation and the voting implementation including as network element at least the following:
territorial sites placed in voting regions and providing at least:
open acquaintance with the information on the forthcoming voting;
registration of voters;
presenting to the voter of a bulletin containing at least two selection variants and made on a suitable carrier with a possibility of making a mark in the selection field;
calculation of quantity of the issued bulletins;
reception of the bulletin filled by the voter;
calculation of a number of accepted bulletins;
calculation of quantity of marks made by the voter with respect to a selection variant; and
a central control station interconnected by means of suitable communication facilities, said sites being adapted at least for capture, reception, registration, processing, saving and delivery of information in a preset format;
an automated operational information system including a necessary amount of elements of the system composing in combination a territorially distributed structure having central and peripheral elements connected to each other and connected to all other elements of the system, and a server, in which the connection between the elements is effected by means of suitable communication facilities like an Intranet network, and each of said automated system elements includes complexes of soft/hardware means provided with the standard program-technical means allowing one to perform on-line automatic loading, adjustment, monitoring and correction of their state in real time and/or in session time;
reception of information containing information objects prepared by the voting network elements in a preset format, and input of the information objects in the element of the automated system;
processing said information in a digital form to generate data blocks containing said information objects and providing a possibility of their display as a text and/or graphics and/or digits and/or a table with a possibility of editing said image;
review of the displayed information objects, checking their correspondence to the initial information prepared by the voting network element;
input of additional data in said information objects allowing one to identify said information as information relating to the election in a definite instant of time and to identify the element of the automated system providing input of said information into said automated system;
subsequent recording and storing said information objects with a possibility of data processing by the cumulative total method;
transfer of said information objects to the other elements of the system;
display and visualization of said information objects;
saving said information objects;
identification of the user of the automated system at his call to the automated system element; the database server is also adapted to automatically create a common database by:
reception, record, accumulation and saving of the information objects incoming in real time and/or in session time from the automated system elements;
processing the received information objects with creation of address blocks including information objects relating to one type of voting and/or one element of automated system and/or to one of the voting network element and/or one direction of activity of the system elements and/or one user, and savings of the address blocks with a possibility of their recovery;
processing the information on the address blocks with creation of final data blocks containing information with cumulative total and saving the final data blocks with a possibility of their recovery;
processing the information contained in said data blocks, address blocks and final data blocks with creation of statistical data blocks by the parameters prescribed by normative legal acts and their saving with a possibility of their recovery;
providing each of said address blocks with final data of an additional classification index allowing each of said blocks to be identified in the database;
saving the software packs installed in the automated system elements including the initial and service packs, and the results of testing the state of the soft/hardware means of the automated system elements during monitoring;
generation of data blocks containing information stored in the common database according to the dispatch regulations provided for the users registered in the database;
generation of open data blocks according to the prescribed list of information for the future open representation by means of visualization tools;
generation of information objects according to the installed list of information for the subsequent allocation on sites of the Internet network;
saving the copies of the initial and updated data blocks of the common database on a carrier suitable for operation in an automated system not linked to the database;
registration of the issue and movement of strict accountancy documents including voting bulletins;
creation of a voting bulletin block containing information allowing one to identify the bulletin as a voting bulletin including at least two selection variants from the registered selection variants and having at least two localized selection fields adapted for making the election by introduction a marking element by the voting participant in one of the selection fields; and the automated system provides a possibility of:
data exchange between the voting network elements and the automated system elements;
supports of operation of the system and common database in an interactive mode for directory service of the users, automated system elements and voting network elements with performance of a complex of works on:
maintenance of the information contained in the common database in an actual state by means of its correction and updating;
reception of users call to the common database and saving this call;
verifying whether the call has an identification index, verification of the user's access rights given of the calling user concerning the access to the information stored in the common database,
search of information in the common database associated with the user's call and checking the user authorization,
creation of a response to the user call,
sending a response to the user in the browse mode according to the scope of rights of the calling user if the user call to the database includes an identification index corresponding to the identification index of this user in said common database;
automatic performance of a complex of operations on protection of the automated system against an unauthorized access;
a complex of operations on information security;
in which case at least one of the central elements is a central control element of said system and is also adapted for monitoring the operation of the other elements of the automated system, and the automated system includes:
at least one system element adapted for connection with other databases and made with a possibility of reception of a request from a system element containing at least data on the information object requiring an explanation and/or additional information from the other databases and identifying the index of a system element producing a request, its direction to the other databases, receptions of an answer and direction of the answer to the system element which have sent the request;
at least one system element connected to one central element and to the database server of the system and used for:
user access to the information resources of the automated system via the Internet network;
on-line access to the information on the course of voting and on the preliminary voting results being automatically processed in a real-time mode in the voting region by means of a suitable interface and displays;
publication in the Internet network of the information on the course of voting and the total voting results within 24 hours after the voting is over;
displaying of the information on the course of voting and voting results on a large multiple-access display.

21. The system as claimed in claim 20, characterized in that the territory of distribution of the peripheral elements of said automated operational information system is a voting region.

22. The system as claimed in claim 20, characterized in that give to users are submitted with information generated in blocks:
information on the beginning of the election campaign;
data including regulatory legal acts regulating the activity on the voting preparation and implementation and necessary legal information;
data containing time schedules of work on voting preparation and implementation and on the final voting results;
data containing information on administrative territorial division of the voting region;
data on the operation of the central control station and territorial voting network sites during the voting preparation and implementation;
data including documentary forms prescribed for reports in various organizational structures connected with the voting with a possibility of filling these forms,
data including preliminary, current and total reports on the voting preparation and implementation;
data generated in the course of the voting preparation and implementation by each automated system element,
data on the voting preparation and implementation at a definite site of the voting network,
data on the object to be included in the number of selection variants for voting;
data including a list of registered selection variants for voting,
data on prospective voters;
data including lists of prospective voters according to the administrative territorial division of the voting region;
data including a form of the voting bulletin and requirement to its content;
data on the formed voting bulletin with a possibility of its duplication on a carrier acceptable for voting;
data on registration of the voter and on the voting bulletin submitted to him;
data including lists of registered voters including results of checking said lists for the presence of “doubles”,
data on the voting process dynamics and on the quantity of cast votes during the voting time;
data containing information on the beginning, end and content of the agitation campaign in a voting region;
data containing information on the voting summary in the voting region and/or its administrative-territorial voting sites;
data containing information on the documents granted to the elected person,
data of the statistical processing of the obtained information supplied from the system elements and from the voting network elements in the process of voting preparation and implementation;
information on closing the voting;
data containing information on arrival, expenditure and return of monetary funds intended for voting preparation and implementation;
information on termination of the election campaign;
information on termination of the powers of an official and/or authority;
information on granting the powers to the elected official and/or authority;
information submitted in accordance with a prescribed list of information given for the future open access to mass media and/or acceptable visualization tools;
information submitted in accordance with a prescribed list of information submitted for future display on sites of the Internet network;
information on the operation of the soft/hardware elements of the automated system and communication facilities and on the results of monitoring their status and service with a possibility of displaying the information contained in said blocks on a display.

23. The system as claimed in claim 20, characterized in that the data containing information on the regulatory legal acts, regulating activity on voting preparation and implementation at least include:
voting type and purpose;
voting region and its division into administrative-territorial sites for voting preparation and implementation;
date and time of the beginning and end of the voting preparation procedure;
date and time of the beginning and end of the voting;
criteria on estimation of the selection variant for its registration as a variant given for voting in the voting region and/or its voting sites;
voting resources rendered to the voter for realization of his/her selection rights;
voter identification parameters;
criteria for recognizing the voter as registered for voting purposes;
criteria for recognizing the bulletin filled by the voter as valid and for the selection being made;
criteria for recognizing report of the site of the voting network on the voting results as valid;
criteria for recognizing the voting as implemented;
indexes assigned to said type of data for their identification in the common database information content.

24. The system as claimed in claim 20, characterized in that the data on operation of the central control station and territorial sites of a network of the voting, carrying out the voting preparation and implementation at least include:
regulatory legal acts regulating their action;
functional features of said sites, their interaction, and a hierarchic structure of the voting network;
prescribed forms of accounts and reports;
information on the personnel;
a scope of rights given to the personnel for carrying out their activity;
information on special identification indexes assigned to each of the elements of the system, which must be included in the volume of the information block generated by said elements for input into said common database and/or for transfer to other elements and/or automated system, and allowing said automated system to identify the data source, and the information by accessory;
data generated in the course of the voting preparation and forming voting documents including accounting documents;
information generated by the element of the automated system in said data blocks containing information received by the system in the course of the voting preparation and implementation, and providing a possibility of its display in the form of a text and/or graphics and/or digits and/or a table;
date and time of the beginning and end of the activity of said voting network cites.

25. The system as claimed in claim 20, characterized in that the data containing information on the administrative territorial division of the voting region, contain an image of a map of the voting region with an indication of the boundaries of division of the region into sites for voting with a possibility of detailing of parameters of a site.

26. The system as claimed in claim 20, characterized in that the data on the object to be included in the number of selection variants presented for voting contain at least:
parameters allowing one to identify an object of a supposed selection among the other supposed selection objects;
data necessary for conduction by the voter of comparative estimation of the selection variants;
data registered according to the requirements of the regulatory legal acts for selection variants submitted for voting, in the scope of data necessary for conduction of comparative estimation of the selection variants;
information on the selection variants which have been given up in registration, and on the reasons of such a refusal.

27. The system as claimed in claim 20, characterized in that the data on the prospective voter contain at least:
data on the person who has reached the age of legal capacity for voting residing within the administrative-territorial site of the voting region allowing the system to identify him among the other persons living in this area,
data on the voting process participant necessary and sufficient for his identification among prospective voters,
a list of prospective voters reached the age of legal capacity for voting and living in one of the administrative-territorial sites of the voting region,
data on the person who has reached the age of legal capacity for voting who expressed a desire to vote at a voting site which is not his residence place,
data of the documents given to the voter by his request for voting at a voting site which is not his residence place.

28. The system as claimed in claim 20, characterized in that the voting purpose is selected from the group including a referendum, presidential election, election of a higher official, election of a head of a municipal union, election of a head of administration, election of a deputy, a recall of a person from an elective post, a recall of a deputy, and system has structure of interaction of the system elements among themselves and with network elements of the voting corresponding to the purpose of voting and to voting region.

29. The system as claimed in claim 20, characterized in that the voting type is selected from the group including direct voting and correspondence voting.

30. The system as claimed in claim 20, characterized in that the voting region is selected from the group including a state, a federal division, a subject of the Federation, a municipal union, an administrative-territorial site.

31. The system as claimed in claim 20, characterized in that it allows voting preparation and implementation to be effected in one voting region carrying out simultaneously for several purposes of voting in any combination of purposes and voting types.

32. The system as claimed in claim 20, characterized in that the voting is conducted for an objective of a referendum, a recall of a person from an elective post, a recall of a deputy, a selection variant being an answer at least on one question, the bulletin has at least two selection fields for the answer to one question, and the answer is fixed in the bulletin by making a mark in one of the two selection fields.

33. The system as claimed in claim 20, characterized in that the voting preparation and implementation is effected for a purpose selected from the group including presidential election, election of a higher official, election of a head of a municipal union, election of a head of administration, election of a deputy, when creating a common database of the automated system additional information objects are generated, which contain:
data on registration of an election campaign with assignment to it a special coded index which must be included in the data blocks concerning the voting preparation and implementation for the selected purpose, and allowing one to identify such information in the common database information content;
information on the beginning of the election campaign;
information on the beginning and end, and on the content of the agitation campaign;
information on the termination of the election campaign;
information on the termination of the powers of the official and/or authority;
information on granting the powers to the elected official and/or authority;
data on the election collectives including political parties and/or election blocks and/or initiative groups of voters slating a candidate including:
information on the involvement of said election collectives in election campaigns;
information on the authorized representatives of the election collectives;
data on the candidate slated by the election collective including data on his property and income;
data on the authorized representatives of the candidate;
data on the documents given to the registered authorized representative;
data on the candidate;
data on the arrival and expenditure of the money resources of the election funds of the candidates and on the obtained budgetary funds including for free broadcast time and printing areas;
data on registration of a candidate to be included in the voting list as a voting object;
data on the documents granted to the elected person;
the results of monitoring the legitimacy of the donations;
the results of checking the data on the candidate property and income; and additionally the automated system is used for forming and giving to the elected person a document for his election.

34. The system as claimed in claim 20, characterized in that the automated system elements are arranged in places of allocation of the voting network elements.

35. The system as claimed in claim 20, characterized in that the voting network has a multilevel structure according to the established administrative territorial division of the voting region and the hierarchy of the voting network elements.

36. The system as claimed in claim 20, characterized in that the parameters of voter identification include a surname, a name, a patronymic, a date of birth, a birthplace, a residence or registrations and an identity card.

37. The system as claimed in claim 20, characterized in that the information submitted to the user for review is in the form of data blocks to be displayed on a display and selected from the group including:
a data block containing an index identifying this user;
a data block containing information permitted for access to the user authorized for this access;
a data block for open acquaintance.

38. The system as claimed in claim 20, characterized in that it is adapted for imaging in real-time mode and/or in a session time mode of statistical information on the course of voting preparation and implementation on an appropriate cartographic map of the territory and/or sites of the administrative territorial division of the voting region and/or voting region as a whole.
